(19) United States
(12) Patent Application Publication
(10) Pub. No.: US 2010/0153286 A1
(43) Pub. Date: Jun. 17, 2010

(54) Electronic Contact and Media Distribution System

(75) Inventors: Ty Joseph Caswell, Zimmerman, MN (US); Jason Andrew Caswell, Elk River, MN (US)

Correspondence Address: MERCHANT & GOULD PC, P.O. BOX 2903, MINNEAPOLIS, MN, 55402-0903, US

(73) Assignee: Crick Information Technologies, inc., Maple Grove, MN (US)

(21) Appl. No.: 12/579,135

(22) Filed: Oct. 14, 2009

Related U.S. Application Data
(60) Provisional application No. 61/220,495, filed on Jun. 25, 2009.
(60) Provisional application No. 61/159,691, filed on Mar. 12, 2009.
(60) Provisional application No. 61/105,296, filed on Oct. 14, 2008.

(51) Int. Cl. G06Q 99/00; G06F 17/30; G06F 15/16; G06Q 50/00

(52) U.S. Cl. 705/319; 707/802; 709/204; 707/705; 707/E17.005; 707/E17.107

(57) ABSTRACT

An electronic information distribution system, and methods of use are disclosed. The system includes an attendee handheld computing device and an exhibitor data exchange system including an exhibitor computing device and a wireless communication unit. The system also includes a database configured to contain database records, the database records including database records related to an owner of the attendee handheld computing device and database records related to a registered user of the exhibitor data exchange system. The attendee handheld computing device is configured to exchange information with the wireless communication unit via a wireless communications link, thereby forming a link in the database between at least one record related to the owner of the attendee handheld computing device and at least one record related to the registered user of the exhibitor data exchange system.

### CROSS-REFERENCE TO RELATED APPLICATIONS

The present application claims priority to U.S. Provisional Patent Application No. 61/220,495, filed Jun. 25, 2009, U.S. Provisional Patent Application No. 61/159,691, filed Mar. 12, 2009, and U.S. Provisional Patent Application No. 61/105,296, filed Oct. 14, 2008. The disclosures of all of these applications are hereby incorporated by reference in their entireties.

### TECHNICAL FIELD

The present disclosure is generally related to systems and methods for the exchange, storage and organization of information. More specifically, the present disclosure is directed to an electronic contact and media distribution system, such as for information collected at a trade show event, open house, or other in-person exchange.

### BACKGROUND

An event such as a conference, a seminar, open house, or a trade show presents a unique networking forum where participants congregate with an intention to exchange ideas and information. In general, it is in the participants' best interest to streamline the exchange of information; however, this presents a unique set of problems for participants who have related yet dissimilar agendas.

For example, in the context of a trade show, an attendee is primarily interested in non-invasively obtaining and holding information from both an exhibitor and other attendees alike. In contrast, an exhibitor is driven to generate comprehensive demographic information based on attendee interest in products and/or services in a manner that simultaneously caters to attendee sensibilities. Additionally, the exhibitor is interested in interacting with trade show attendees during the trade show, and easing tension or anxiety commonly experienced in a “cold-contact” interaction. Further, both attendees and exhibitors alike wish to conveniently obtain and manage product literature, contact information, and various other information collected from trade show participants.

In another example, at an open house hosted by a realtor at a house to be sold, the attendees are interested in collecting information about the property, while a realtor exhibiting the property wishes to collect identity, demographic, and other information about those open house attendees. This can be difficult if there are a large number of attendees at the open house, or if the attendees simply do not wish to talk to the realtor. In other events in which data is to be exchanged, attendees and exhibitors may have different reasons for exchanging information and literature, which may be voluminous.

Consequently, it is desirable to provide a robust system for the exchange and organization of information that substantially addresses the requirements of every type of event participant.

### SUMMARY

In accordance with the following disclosure, the above and other considerations are addressed by the following:

In a first aspect, an electronic information distribution system is disclosed. The system includes an attendee handheld computing device and an exhibitor data exchange system including an exhibitor computing device and a wireless communication unit. The system also includes a database configured to contain database records, the database records including database records related to an owner of the attendee handheld computing device and database records related to a registered user of the exhibitor data exchange system. The attendee handheld computing device is configured to exchange information with the wireless communication unit via a wireless communications link, thereby forming a link in the database between at least one record related to the owner of the attendee handheld computing device and at least one record related to the registered user of the exhibitor data exchange system.

In a second aspect, a method of distributing information at an event is disclosed. The method includes generating a record of exhibitor information including contact information and electronic literature or media. The method further includes wirelessly distributing a link to the exhibitor information at the event, in response to a wireless request from an attendee handheld computing device. The method also includes wirelessly receiving information about an event attendee from the attendee handheld computing device. The method further includes accessing, via a web portal, an event attendee contact information organization system containing information about the event attendee.

In a third aspect, a method of collecting exhibitor information at an event is disclosed. The method includes receiving an attendee handheld computing device and linking the attendee handheld computing device to an attendee record. The method further includes orienting the attendee handheld computing device toward a wireless communication unit of an exhibitor data exchange system and activating the attendee handheld computing device, thereby exchanging information with the exhibitor data exchange system. The method includes accessing, via a web portal, product literature or media related to an event exhibitor associated with the exhibitor data exchange system.

In a further aspect, an information network for accessing and managing a plurality of media and contact information exchanged at an event environment between a plurality of event participants is disclosed. The information network includes a database containing an allocated memory space for each event participant to store media and contact information and one or more database servers. Using the information network, the event participants can access and organize media and contact information by accessing the one or more database servers with a general purpose computing device running an instance of a Web-based software application.

In yet another aspect, a method of providing equipment for electronic literature distribution in an event environment is disclosed. The method includes providing a remote database configured to store exhibitor information and attendee information, and providing a plurality of data exchange devices to a plurality of exhibitors, each of the plurality of data exchange devices communicatively connected to the remote database. The method includes charging each of the plurality of exhibitors a fee related to the data exchange devices provided to that exhibitor, the fee based on a number of expected attendees at the event, each data exchange device including a display and an optical interface. The method further includes providing, at no cost to attendees, a personal communication device to each of a plurality of attendees of the event, the personal communication devices configured to communicate with each of the plurality of data exchange devices via an optical interface. The method also includes providing a kiosk useable by the attendees to associate the personal communication device with personal information of that attendee, the kiosk communicatively connected to the remote database and configured to transmit the personal information of each of the attendees to the remote database. The method includes hosting a Web application accessible to the plurality of exhibitors and the attendees, the Web application providing access to information exchanged between the personal communication device associated with an attendee and the plurality of data exchange devices to the attendee.

In a further aspect, a method of validating sales leads collected using an event electronic literature distribution system is disclosed. The method includes providing access to electronic content in a database to an event attendee, the electronic content including content associated with an event exhibitor. The method also includes detecting accesses of the electronic content by the event attendee and logging the accesses of the electronic content by the event attendee in an access log. The method further includes generating a report describing at least a portion of the access log and transmitting the report to the event exhibitor.

### BRIEF DESCRIPTION OF THE DRAWINGS

FIG. 1 is an example system and method to facilitate electronic contact and media information exchange between an event attendee and one or more event exhibitors and/or other attendees from the perspective of the attendee;

FIG. 2A is an example system and method to facilitate electronic contact and media information exchange between an event exhibitor and one or more event attendees from the perspective of the exhibitor;

FIG. 2B is a further example system and method to facilitate electronic contact and media information exchange between an event exhibitor and one or more event attendees from the perspective of the event exhibitor;

FIG. 3 an example event environment incorporating aspects of the systems and methods of FIG. 1 and FIGS. 2A-2B;

FIG. 4 is a block diagram of an example personal communication device;

FIG. 5 is a schematic diagram of the personal communication device of FIG. 4;

FIG. 6 is front view of an example kiosk;

FIG. 7 is an example data exchange system;

FIG. 8 is an example communication unit coupled to gooseneck clamp fixture;

FIG. 9 is a block diagram of the communication unit of FIG. 8;

FIG. 10 is an example network for accessing and managing a plurality of media and contact information;

FIG. 11 shows an example user interface displaying a tray including a feature to launch an instance of Web-based software application;

FIG. 12 displays an example user interface useable for contact management;

FIG. 13 displays an example user interface useable as a contact information form;

FIG. 14 displays an example user interface useable for contact management;

FIG. 15 displays an example user interface generated by an explorer module;

FIG. 16 displays an example user interface useable for information and literature management;

FIG. 17 illustrates a flowchart of methods and systems for data transfer between an event attendee personal communication device and an exhibitor communication unit;

FIG. 18 illustrates a flowchart of methods and systems for data transfer between an event attendee personal communication device and an exhibitor communication unit according to a further embodiment;

FIG. 19 is a block diagram illustrating example physical components of an electronic computing device useable to implement the various methods and systems described herein;

FIG. 20 illustrates a block diagram of a system and method for managing compensation for use of an event exhibition, according to a possible embodiment of the present disclosure;

FIG. 21 illustrates a flowchart of methods and systems for automatic qualification of sales leads; and

FIG. 22 illustrates an example user interface useable to display a report of qualified sales leads.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments possible.

In general, the present disclosure is directed towards systems and methods for the distribution, collection, and organization of electronic contact and media information in the context of an in-person event such as a trade show, open house, or other exhibition. The techniques provided herein are applicable to any situation where the electronic exchange and organization of information is desired. The term “media” used herein generally relates to any form of electronic data. For example, media may include document data, communications data, application data, or any other forms of data. Further, media can include any type of informational material such as brochures, pamphlets, price sheets, and any other products and services information. As described herein, the present disclosure provides an environment in which the contact and media information can be electronically exchanged, thereby avoiding the extensive costs, logistical difficulties, and delay times required for distribution of printed materials. Using electronic media and contact distribution, costs for event infrastructure and printing can be reapportioned to devices which enhance the event experience for attendees, exhibitors, and advertisers.

In the present disclosure, individuals having an interest in performing an information exchange at such an event have diverse interests, and can generally be categorized as exhibitors, advertisers, and attendees. Exhibitors can include the host for an event, as well as individuals or entities having literature materials to distribute at an event. In the case of a trade show, exhibitors include those individuals and entities distributing product or service information from a trade show exhibit location (e.g. an exhibitor booth). In the case of an open house, an exhibitor is typically a realtor or homeowner wishing to display a property and provide information about that property to prospective homebuyers. Alternatively, the exhibitor could be a manufacturer of features within a house, or supplier of goods or services displayed at the property. In other instances of in-person events, the exhibitor may be other types of entities.

Advertisers can be entities or individuals that do not necessarily have a personal presence at the event, but wish to at least passively display product or service information to attendees. Advertisers generally will display information about third-party products or services, which are not necessarily the focus of the event. For example, in the context of a trade show, an advertiser may display signage for related products or services, but may not have a presence in a trade show booth. In the context of an open house, the advertiser could be for a related service, such as home inspections, home improvement, relocation services, or other related services. Attendees are generally those individuals present at the in-person event and seeking to collect information from the event exhibitors.

The various embodiments of the present disclosure are implemented as: (1) a handheld computing device configured to communicate with a plurality of compatibly configured: (a) general purpose computing devices, (b) communication computing devices, and (c) other handheld computing devices, for the purpose of exchanging media and contact information; and (2) a Web-based software application, including a plurality of supporting resources, for the purpose of storing and organizing media and contact information.

It will be appreciated by those skilled in the art that, in a most basic hardware configuration, a computing device includes a processing device, one or more computer readable media, and a communication device. Other embodiments of a computing device are possible as well. For example, a computing device can include a user interface, an operating system, and one or more software applications. Several example computing devices include a personal computer (PC), a laptop computer, a personal digital assistant (PDA), and a smartphone such as a Blackberry, iPhone, Treo and others. Further, a Web-based software application or a “software as a service” application is supported by a plurality of resources including one or more Web servers, one or more mass storage databases formatted accordingly, and other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11a/b/g network, radio frequency, infrared, serial, or any other data connection. In general, the communication between one or more computing devices configured with one or more communication devices is accomplished via a network such as any of a number of wireless or hardwired WAN, LAN, Internet, or other packet-based communication networks.

In certain embodiments of the systems of the present disclosure, a personal communication device (PCD) or communication system are described. These systems are intended to, in different embodiments, support either one way or two way transmission of data. The personal communication device, as it is used herein, is therefore intended to at least encompass devices containing a transmitter, a receiver, a transmitter and receiver, or a combined transmitter-receiver useable in one-way communication systems, or a transmitter-receiver (integrated or separate components) useable in bidirectional communication systems of any of a variety of media (e.g., radio frequency, infrared, audible, or other communication signal forms).

### A. Operational Systems and Methods for Literature Distribution

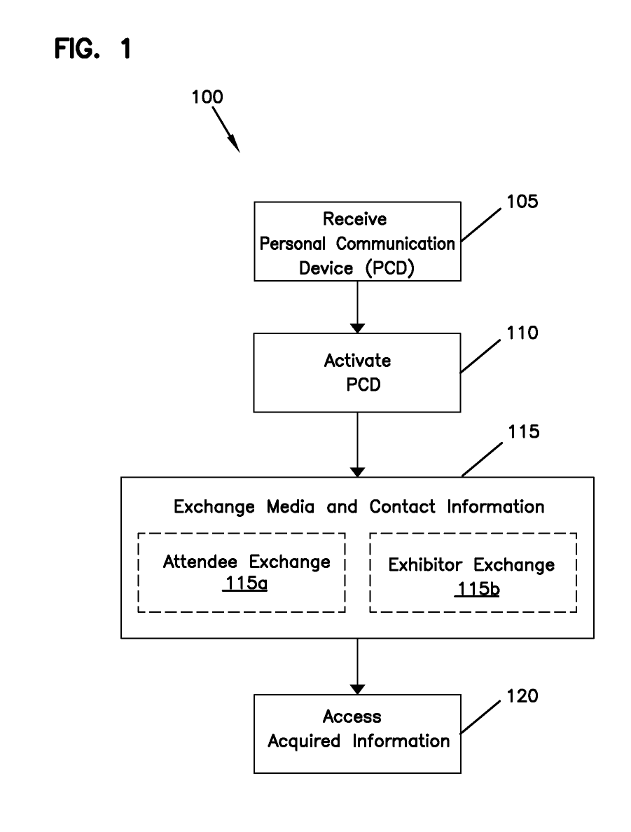

Referring now to FIG. 1, systems and methods to facilitate electronic contact and media information exchange between an event attendee and one or more event exhibitors and/or other attendees from the perspective of the attendee are disclosed. The disclosed systems and methods additionally enable the attendee to organize and manage acquired contact and media information via a Web-based software application. In general, an example method 100 is implemented with a handheld computing device configured in part to communicate with a plurality of compatibly configured general purpose computing devices having an Internet access capability, exhibitor communication computing devices, and other handheld computing devices.

The example method 100 begins at operation 105. At operation 105, the attendee is issued a personal communication device (PCD) upon registration at an event location. In general, the PCD is a handheld computing device having electronic information storage and a communications capability to exchange electronic information with other compatible computing devices. As previously explained, in various embodiments, the PCD can include either a transceiver or transmitter, depending upon its intended use in a single direction or biirectional communications system. In one embodiment, the PCD is a disposable computing device. In an alternative embodiment, the PCD is a reusable, reconfigurable computing device in which an attendee can use a previously-issued PCD that can be programmed to be compatible with and contain information relevant to a current event.

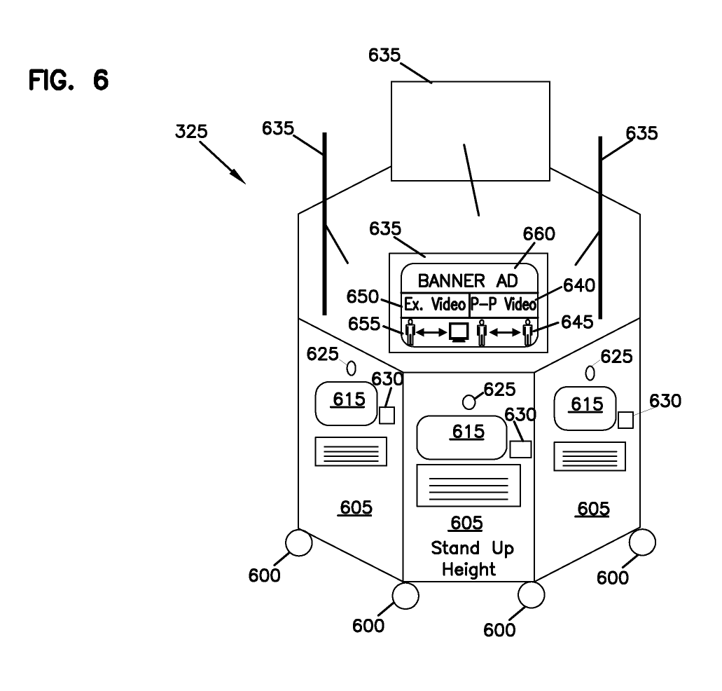

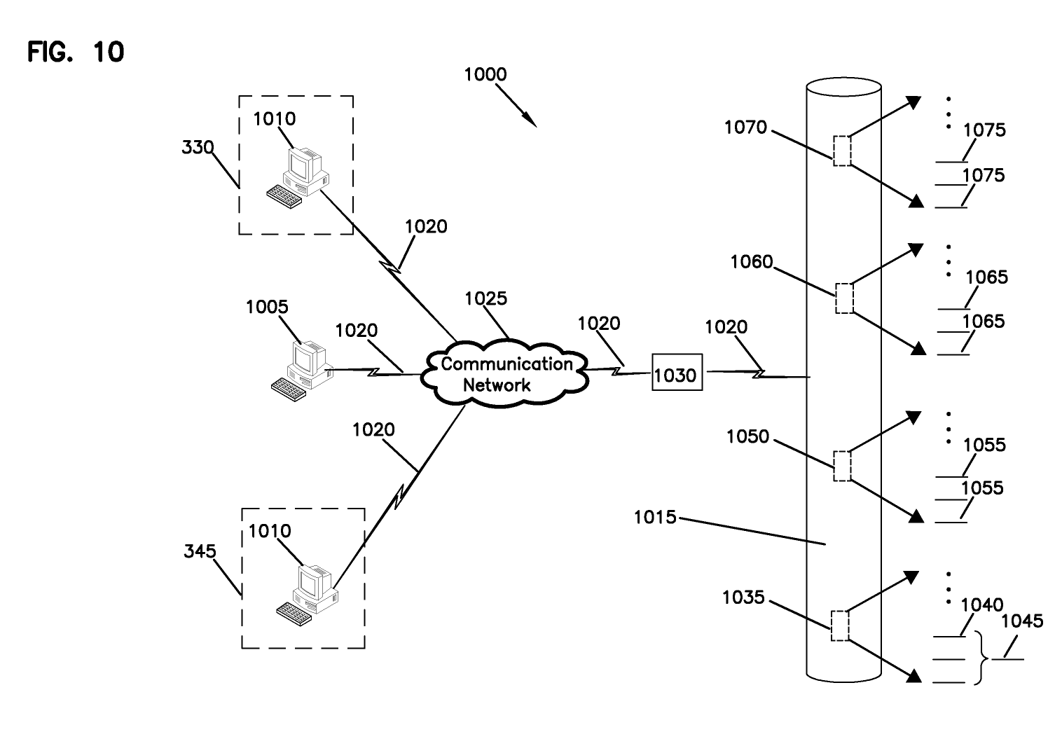

At operation 110, the PCD is activated, or initialized, at a designated location at the event to include attendee specific contact information. In certain embodiments, the designated location is a multi-sided kiosk having a plurality of semi-private user input stations. One example of such a kiosk is described with reference to FIG. 6, below. In other embodiments, the designated location is a booth containing a receiver unit configured to receive a code from the PCD and transmit that code to a database (e.g., as illustrated in FIG. 10), thereby activating the PCD within a trade show or other information exchange environment.

In certain embodiments, the designated PCD initialization location includes at least one general purpose computing device, such as a PC, running a dedicated software application that prompts the attendee to fill out an electronic data entry form containing a plurality of contact information fields. In certain embodiments, a user interface such as a touch screen or a QWERTY keyboard is employed to enter the contact information. In one embodiment, the attendee is prompted to fill in contact information fields such as First Name, Last Name, Middle Initial, Company Name, Phone Number, Email Address, and others. In an alternative embodiment, to facilitate speed and throughput of attendees at the designated location, the attendee may initially only be required to enter First and Last Name and an Email address. Subsequently, at a later time the attendee can be prompted via Email to complete the data entry form in its entirety. In general, the data entry form is stored in a pre-determined electronic file format. In certain embodiments, the file format is an electronic business card format such as the “vCard” format standard.

In certain embodiments, the PCD initialization process at operation 110 is completed by communicatively coupling the PCD to the computing device such that the formatted file containing attendee contact information is transferred from the computing device to the PCD via an established communication link. In certain embodiments, a digital image of the attendee captured at the designated location is additionally transferred to the PCD during the initialization process. In alternative embodiments, the PCD initialization process is completed by sending from the PCD to the kiosk an identifier of the PCD. The identifier (e.g. a globally unique code, such as a GUID or other set of bytes such as a 6+ digit code, stored in the memory of the PCD) can be linked to the entered information, and associated with the electronic business card such that the identifier can identify the individual within a database containing such information (as explained in conjunction with FIG. 10, below.

At operation 115, the attendee proceeds to participate in the event with the intent to voluntarily exchange media and contact information with other event participants. In general, event participants include at least a plurality of other attendees and exhibitors. In example embodiments, each of the respective attendees is provided with an initialized PCD. Additionally, each of the plurality of exhibitors are assigned an area (e.g., a trade show booth or other exhibition area) having, in part, a dedicated data exchange system compatibly configured to electronically exchange media and contact information with a respective attendee via the initiated PCD.

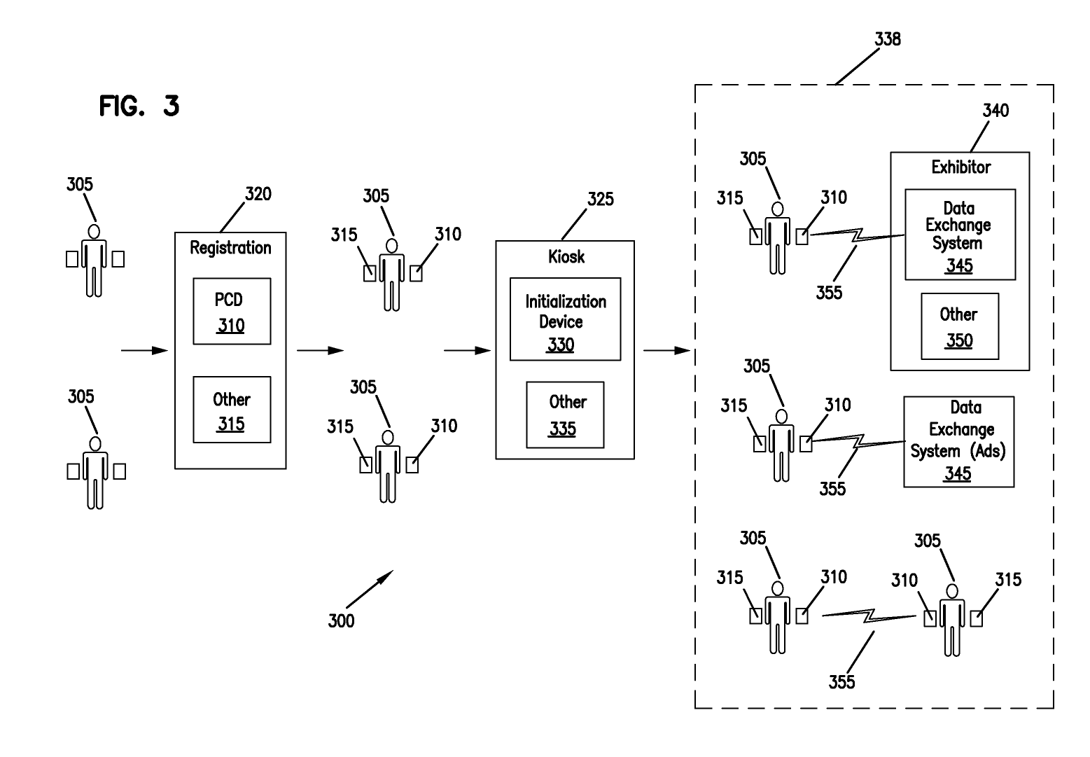

In general, at operation 115 an attendee exchanges electronic media and contact information with one or more other attendees occurs at module 115a. Further, an attendee exchanging electronic media and contact information with one or more exhibitors occurs at module 115b. The exchange with exhibitors at module 115b can include information exchange with exhibitors present at the event, as well as exchange with advertisers having analogous display functionality at the event, as explained in conjunction with FIG. 3, below.

In certain embodiments, the information exchange at respective modules 115a and 115b is accomplished via a wireless communication protocol initiated by the attendee upon actuation of a control button incorporated into a PCD device. In one aspect, the information exchange is via infrared, laser, or other optical communications; however, any frequency band of the electromagnetic spectrum can be utilized depending on the communication technology employed. In the example embodiments employing optical technology, both attendee and exhibitor information exchange devices (i.e., PCD and data exchange system) are configured to include an optical communications port. In this manner, at module 115a an attendee orients the respective PCD optical communication port towards a second PCD optical communication port and, following a brief communication protocol sequence, an information exchange occurs, described in further detail below. In certain embodiments, the information exchange involves the transfer of contact information. In other embodiments, other information such as acquired exhibitor electronic literature can additionally be exchanged. In further embodiments, the information exchange involves the transfer of an identifier of the attendee, as stored in the device. In certain embodiments, a complete PCD-PCD information exchange transaction occurs between about 0.1 seconds and 1 second. In a preferred embodiment, a complete PCD-PCD information exchange process occurs between about 0.1 seconds and 0.5 seconds.

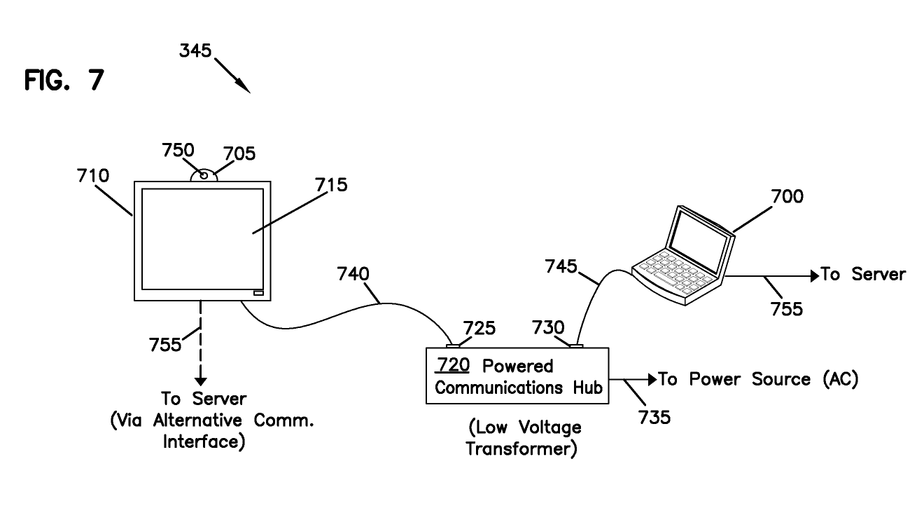

Attendee information exchange with one or more exhibitors at module 115b occurs in a similar manner to module 115a. In general, the attendee orients the PCD optical communication port towards an optical transceiver incorporated into the exhibitor data exchange system. Following a brief communication protocol sequence, the PCD transfers the attendee contact information to the exhibitor optical receiver or transceiver and receives exhibitor media information literature, described in further detail below. In certain embodiments, a complete PCD-exhibitor information exchange transaction occurs between about 0.1 seconds and 1 second. In a preferred embodiment, a complete PCD-exhibitor information exchange transaction occurs between about 0.1 seconds and 0.5 seconds. Details regarding a possible embodiment of a data exchange system are described with reference to FIGS. 7-9 below.

At operation 120, at any time during or after the event the attendee can interface the PCD with a computing device, such as a personal laptop, a PC, or a smartphone, to access and optionally download the acquired media and contact information from the PCD and from the internet. In certain embodiments, a USB connection is established between the PCD and the computing device. In one example embodiment, the attendee accesses the acquired media and contact information via an instance of a Web-based software application running on the computing device. In the described embodiment, the attendee may be required to initially log-on to the Web-based software application. In general, the software application can be utilized to retrieve, view, and/or organize exhibitor media collected from an exhibitor at the event. In a similar manner, contact information collected from other attendees can be retrieved, viewed, and/or organized.

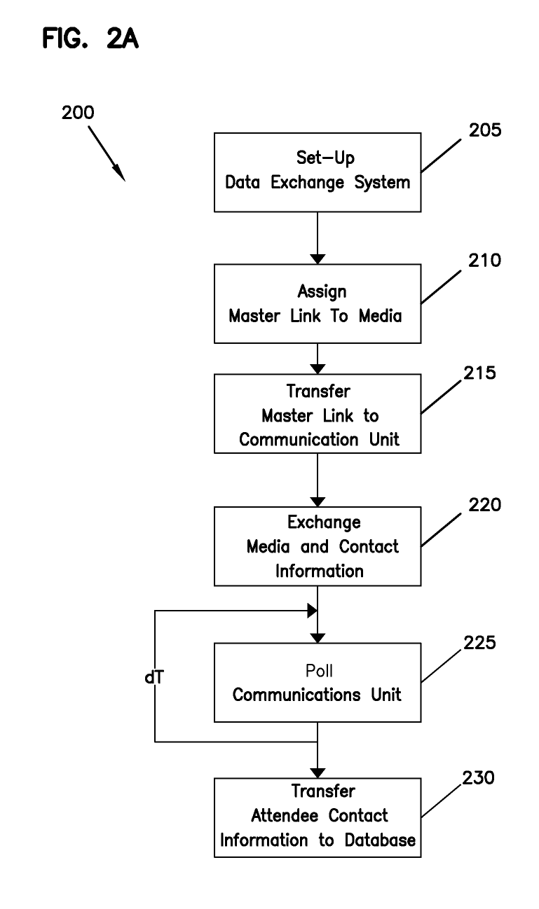

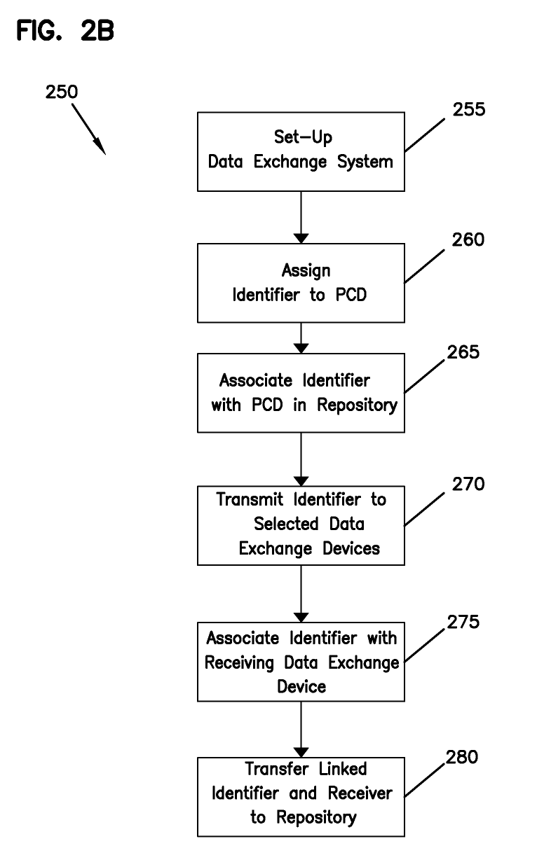

Referring now to FIGS. 2A-2B, systems and methods to facilitate electronic contact and media information exchange between an event exhibitor and one or more event attendees from the perspective of an exhibitor are disclosed. The disclosed systems and methods additionally enable a respective exhibitor to organize and manage the distribution of both media via a Web-based software application and acquired attendee contact information. In general, an example method 200 is shown in FIG. 2A as implemented with an interconnected data exchange computing system including at least one general computing device having an Internet access capability and at least one transmitter/receiver or other type of communication unit for the exchange and distribution of electronic information with a plurality of event attendees. The systems and methods of FIGS. 2A-2B are applicable in a number of contexts, such as in connection with a trade show, open house, or other exhibition.

The example method 200 begins at operation 205. At operation 205, an interconnected data exchange computing device system is set-up by the exhibitor at an exhibitor's designated location at the event (e.g. the property, booth at a convention center, etc.). In example embodiments, the data exchange system includes a general purpose computing device and a communication unit. In certain embodiments, the communication unit is integrated into a frame assembly along with a display screen, such as a liquid crystal display (LCD). The general purpose computing device can be, for example, a PC running an instance of Web-based software application for controlling the communication unit. Details regarding a typical exhibitor event display arrangement and a possible embodiment of a data exchange system are described below in conjunction with FIG. 7.

At operation 210, an Internet address link for a plurality of exhibitor media, such as for documents describing items and/or services the exhibitor is promoting at the event, is entered into the PC via the Web-based software application. For example, an Internet address link for a brochure, one or more vCards, and other media is entered into predefined data fields in the software application. In certain embodiments, the software application transfers the defined Internet address links to a database for storage. In one embodiment, the software allocates a single master link to represent a path to the group of Internet address links stored in the database. Further details regarding an example embodiment of a storage database and the assignment of a master link allocation to Internet address links are described in conjunction with FIG. 10, below.

At operation 215, the software application transfers the master link representing the path to the group of Internet address links to the communication unit via the USB connection. In the example embodiment, the master link minimizes communication unit response time to an attendee PCD information request. In general, the software application can poll the master database at any time to transfer an updated master link to the communication unit to reflect changes in desired exhibitor media to be distributed.

At operation 220, a voluntary exchange media and contact information between the exhibitors and one or more attendees during an event occurs, as described above. In one example embodiment, an information transaction between an attendee and the exhibitor consists of the respective attendee PCD transferring contact information (e.g., the vCard) to the communication unit and the communication unit transferring the master link representing the path to the group of Internet address links to the attendee PCD. In another example embodiment, the information transaction consists of the attendee PCD transferring an identifier to the communication unit, and the communication unit linking that identifier with an identifier of an exhibitor or advertiser associated with the communication unit. Alternatively, the identifier of the attendee PCD can be linked to the exhibitor at a back-end database (e.g., as shown in FIG. 10). The linked information can be stored in a database to allow the attendee and exhibitor or advertiser to access information about the other party via a Web application as described below.

At operation 225 the software application directs the PC to poll the communication unit for obtained attendee contact information. In certain embodiments, the communication unit is polled with a programmable temporal periodicity, dT, to download obtained contact information to a temporary storage location on the PC. In certain embodiments, upon the exchange of contact information an image of the attendee along with a summarized version of the contact information is immediately displayed on a monitor at the exhibitor location (e.g. as retrieved from a server or received from the PCD). In this manner, an exhibitor can identify and infer knowledge relating to the attendee, such as interests, business title, and other information presented on the attendee vCard. The exhibitor can then address the event attendee and engage in a conversation based on the attendee personal information while at the event.

At operation 230, the software application directs the PC to download attendee contact information from the PC to a database for management and organization. In certain embodiments, the software application is additionally utilized to retrieve, view, and/or organize contact information. In such embodiments, the vCard or identifier information from the attendee can be linked to the exhibitor or advertiser information stored accessible to the Web server, such that either party can access information about the other party through a web application. In certain embodiments, the software application automatically synchronizes vCard information locally stored on the PC with the database. In certain embodiments, the vCards stored in the database can be accessed via a password protected Web portal.

FIG. 2B illustrates an analogous system 250 to the system 200, for exchanging contact information and literature in the event environment. However, the system 250 corresponds to an arrangement using a one-way data communication system in which a PCD identifier associated with an event attendee is transmitted to a data communications device, and then that identifier is subsequently linked to an event exhibitor so that attendees can view literature associated with that exhibitor and the exhibitor can access entered personal information of the attendee.

The system 250 begins at operation 255, which corresponds to set-up of one or more data exchange computing systems by exhibitors at exhibitor event display locations. The operation 255 therefore corresponds to operation 205, described above. However, operation 255 further includes the exhibitor transmitting any materials that they wish to distribute to attendees to an event database of a server (e.g. server 1030 of FIG. 10), which can be managed either locally to or remotely from the event. The exhibitor is then assigned an identifier, which is returned to the exhibitor to be linked to an attendee identifier, as described below.

It is noted that, although discussed in terms of an event exhibitor, the literature distribution could be distribution of advertisements from an advertiser who is not present at the event but who wishes to place a device at the event location for exchanging advertisements for various products, hold sweepstakes or other drawings for prizes, or otherwise communicate with the attendees. Other entities could use such devices at an event as well.

Operation 260 corresponds to associating an identifier with a PCD, such as by pre-loading an identification code into memory of a PCD, or by storing an identification code in the memory of the PCD upon use and registration of the PCD by an event attendee. The identification code can be any globally-unique identification code for that attendee, such that no two attendees at the same event can be confused. In certain embodiments, the identifier is a 6-digit code that corresponds to a user identification code printed on a name badge for that attendee. Other possible codes could be used as well, such as a GUID or other code. Operation 265 associates the identifier in the PCD with information about the attendee in a database. The information about the attendee can be entered by that attendee at a kiosk when registering for a conference, exhibition, or trade show, such as the kiosk shown in FIG. 6. Alternatively, the information can be entered into a webpage either in advance of or after the event. In still other arrangements, operation 265 corresponds to the attendee communicating the identifier to a data exchange unit designated for linking user identities with the user identification code assigned to a PCD. Other arrangements are possible as well.

A transmission operation 270 corresponds to transmitting the attendee identifier to a data exchange device, for example by using a device associated with an event exhibitor, attendee, or advertiser. The data transmission can be a voluntary transmission of the identifier, as elected by the attendee by pointing the PCD toward a data exchange device associated with the exhibitor and activating the PCD, such as by pressing an activation button. At operation 275, the identifier is associated with an identifier of the exhibitor, attendee, or advertiser controlling the data exchange device or PCD receiving the identifier, as mentioned with respect to operation 255. This linked information (the two identifiers) is then transferred to a repository during operation 280. This subsequently allows the linked entities to access information about each other in a Web Application. By transmitting links to information between attendees, exhibitors, and advertisers, it is possible to ensure that viewed information is kept up-to-date by allowing those entities to modify the contact information or literature made available at the link location(s) (e.g. associated with that entity's identifier) in the Web Application.

### B. Event Literature Distribution Environment

FIGS. 3-10 illustrate various components useable to perform the methods and systems described herein, such as could be operated during an event to facilitate the exchange of literature and other information, such as contact information, between event attendees and with exhibitors or advertisers. In FIG. 3, an example event environment 300 is shown incorporating aspects of the systems and methods as described with reference to FIGS. 1 and 2A-2B. The example event environment can be, in various embodiments, a trade show floor, a real estate open house, an exhibition or presentation location, or other in-person event location.

In the example embodiment, the event environment 300 is attended by a plurality of event attendees 305 that register at a registration area 320. At the registration area 320 the attendees 305 are each issued a personal communication device (PCD) 310. In certain embodiments, attendees 305 are additionally issued various other materials 315 at the registration area 320.

In certain embodiments, attendees 305 proceed with the issued PCD 310 to a kiosk 325 that includes an initialization device 330 and other features 335 (e.g., phone, power outlets). In certain embodiments, a plurality of kiosks 325 is provided throughout the event environment 300. In general, the initialization device 330 is used to activate and initialize a PCD 310 for each respective attendee 305 for the current event. Further details regarding an embodiment of a kiosk 325 and initialization device 330 are described in further detail below with reference to FIG. 6. In alternative embodiments, the kiosks 325 can be replaced by data exchange units (e.g. units shown in FIGS. 7-9, below), which are placed at the event and designated for use in linking a user identity (or identification assigned to the user) to a user identification code assigned to the issued PCD.

Event environment 300 additionally includes a primary event area 338 having one or more exhibitor locations 340. In example embodiments, each of the exhibitor locations 340 includes a data exchange system 345 and various other materials 350 (e.g., promotional materials). In the described embodiments, a respective PCD 310 is utilized to exchange information with the data exchange system 345 via a communication link 355. Additionally, a PCD 310 can be used to exchange information with a data exchange system 345 that is not associated with an exhibitor location 340, such as a data exchange system managed and associated by an advertiser not otherwise present at the event. The advertiser may choose to distribute literature without having a dedicated exhibitor location, and may distribute games or sweepstakes entries via the data exchange system 345. Further, a PCD 310 is utilized to exchange information with other attendees in a PCD-PCD information transaction via the communication link 355.

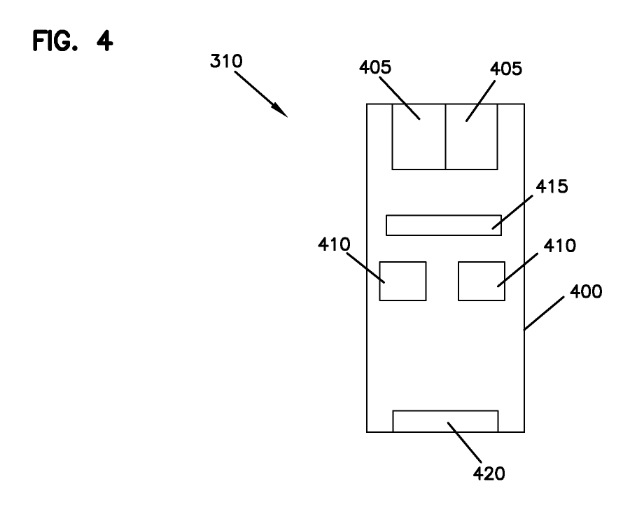

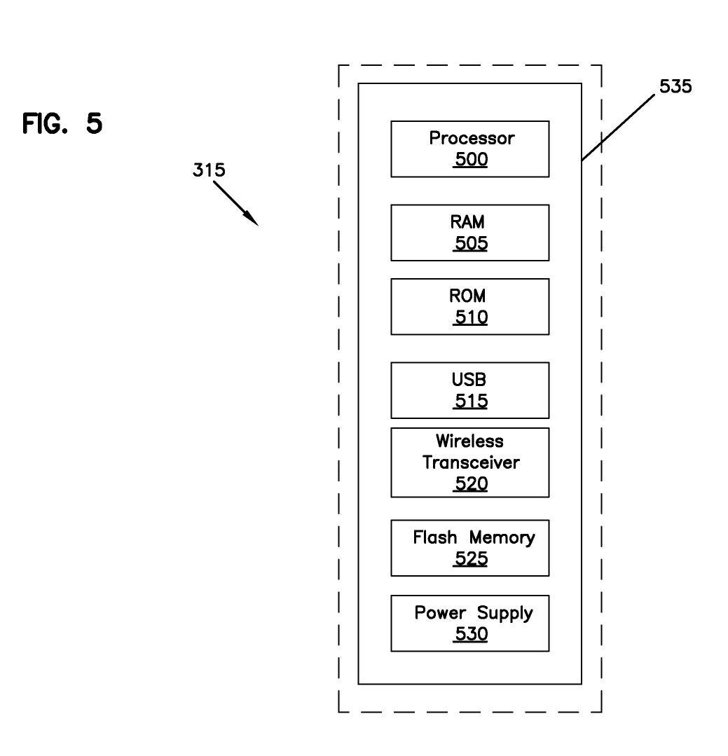

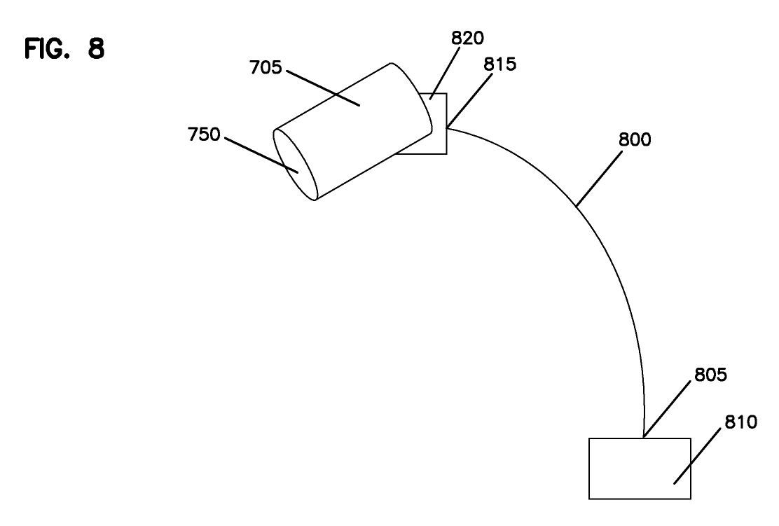

Referring now to FIGS. 4-9, example embodiments of the various elements of the example event environment 300 described with reference to FIG. 3 are illustrated. FIGS. 4 and 5 depict an example embodiment of a PCD 310. FIG. 6 illustrates an example kiosk 325 that can be used in an event environment 300. FIGS. 7-8 illustrate example details of a communication unit, such as can be used in a data exchange system 345.

FIG. 4 is a block diagram representation of the PCD 310 according to a possible embodiment of the present disclosure. In certain embodiments, the PCD 310 is a low-cost, handheld computing device, such as a USB flash drive sized device. In one embodiment, the PCD 310 includes a body section 400, a plurality of communication apertures 405, a plurality of actuable switches or buttons 410, a first surface 415, and a first aperture 420. In certain embodiments, the body section 400 is a molded plastic form having a plurality of ergonomic features to facilitate attendee handling. In general, body section 400 serves to contain a plurality of functional electronic circuitry within an enclosed internal section (not shown).

In certain embodiments, the communication apertures 405 are defined as a wireless communication port and a USB port. In a preferred embodiment, the wireless communication port is an infrared or other optical communications port. Further, in general, the USB port can be any type of USB port. For example, the USB can be a Standard-A connection, a Standard-B connection, a Mini-B connection or other types of USB connections. In a preferred embodiment, the USB port is a Mini-B USB connection.

In various embodiments, the PCD 310 communicates data signals for exchange with a data exchange device, using optical, wireless, or physical communication. For example, a photodiode-based sensor could be included in a translucent signal receipt portion of the incentive distribution unit and used to receive modulated laser signals transmitted optically from a data communications device having an optical interface, such as an infrared or laser-diode arrangement. In alternative embodiments, the PCD only includes a wireless or optical interface, and is powered by disposable batteries. Preferably, the wireless communication media used by the PCD allows for directional communication over a distance sufficient to allow convenient communication from a PCD to a data exchange system present in an event environment. In certain embodiments, the range of communication for a PCD can be approximately 15-50 feet; however, depending upon the particular arrangement of event exhibits, the range may be longer or shorter depending upon the expected spacing between attendees, exhibits, and the possibility of unwanted crosstalk between PCDs.

Although generally reusable, in certain embodiments, the PCD is made from sufficiently low-cost materials as to be disposable after use at an event. Details of such an arrangement are disclosed in U.S. patent application Ser. No. 12/368,874, filed Feb. 10, 2009, the disclosure of which is hereby incorporated by reference in its entirety.

In certain embodiments, the plurality of actuable switches 410 can for example include an on/off switch, a mode switch, a download request switch, and/or others. In one embodiment, switches 410 can be any type of binary switch such as a rocker switch, a pushbutton, and/or any combination of other types of switches such as dials and the like. For example, in one possible embodiment the PCD 310 can be configured operate in a mode that requires a command, such as depressing a respective switch 410, to exchange information with a compatibly configured computing device. Alternatively, the PCD 310 can be configured to operate in a mode that functions as a “listening mode” by depressing a respective switch 410 such that the PCD 310 periodically “sniffs” for a communications signal.

As described above, in certain embodiments the body section 400 can include a first surface 415 and an aperture 420. In one embodiment, the first surface 415 is an ink friendly signature line for labeling with a writing utensil such as a pen or a marker. Further, in certain embodiments aperture 420 can be formed such that a lanyard can be inserted therethrough. In this manner, the PCD 310 can be easily secured and/or transported as desired.

FIG. 5 is a schematic diagram illustrating a plurality of functional modules of the PCD 310 according to a possible embodiment of the present disclosure. In certain embodiments, the PCD 310 includes a processor module 500, a RAM module 505, a ROM module 510, a USB communication module 515, a wireless communication module 520, a flash memory module 525, and a power supply module 530. In example embodiments, respective modules 500, 505, 510, 515, 520, 525, and 530 are positioned on a printed circuit board (PCB) 535 and generally comprise of supporting electronic circuitry to enable the PCD 310 to transfer and exchange information with other various compatibly configured computing devices. In certain embodiments, power supply module 530 is configured to intelligently provide and conserve power delivered to the each respective module 500, 505, 510, 515, 520, 525, and 530. In certain embodiments, PCD 310 is powered by batteries, such as rechargeable batteries, or configured with an alternative power supply such as a solar cell. As previously mentioned, the USB communication module 515 can optionally be removed, and the PCD can in such embodiments include only a wireless communication module 520 for communicating information with data exchange devices (e.g. as shown in FIG. 7). Additional embodiments of PCD 310 are shown and described in U.S. patent application Ser. No. 12/024,349, filed Feb. 1, 2008, and U.S. patent application Ser. No. 12/251,251, filed Oct. 14, 2008, both entitled “Personal Information Communication Device and Method”, the disclosures of both of which are hereby incorporated by reference in their entireties.

Referring now to FIG. 6, an example embodiment of a kiosk 325 is shown according to a possible embodiment of the present disclosure. In general, the kiosk 325 is a multi-sided, mobile event service and education center. In example embodiments, the kiosk 325 includes a plurality of wheels 600 to allow for easy transport. Further, the kiosk 325 includes a plurality of semi-private PCD 310 programming areas 605. In certain embodiments, the respective programming areas 605 include a PC (not shown) having a keyboard 610 and user screen 615 positioned at roughly a “stand-up” height 620 from a ground surface. In certain embodiments, a respective programming area 605 further includes a camera 625 for taking a picture of an attendee and an infrared programming holster 630 for initializing an issued PCD to include various types of personal information and a picture, as described above.

In certain embodiments, an overhead LCD screen 635 is positioned on the kiosk 325 above each respective programming area 605. In general, the LCD screen 635 can be utilized to convey information to an attendee regarding how to use utilize the initialized PCD in the event environment. For example, the LCD screen 635 can display a video demonstrating how to exchange information with an exhibitor at a first sub-screen 640, and with other attendees at a second sub-screen 645. The LCD screen 640 can further display a video demonstrating how to download and access acquired event information at a third sub-screen 650, and other tips on how to successfully exchange information at a fourth sub-screen 655. The LCD screen 635 can further display a series of advertisements at a fifth sub-screen 660.

In use, the kiosk provides a location at which event attendees can enter information upon arrival at the event. In certain embodiments, the kiosk can include one or more computing systems having attendee information stored accessible thereto. The programming areas 605 of the kiosk 325 can operate in an “express” mode or a “registration” mode. The “express” mode allows preregistered attendees to enter an identifier at the keyboard (e.g. the identifier on a name badge which will be used as the identifier for their PCD), and all other information has been previously entered. The “registration” mode requires the user to enter personal information to be exchanged at the event alongside the identifier. In either mode, the camera 625 can optionally be configured to take a picture of the attendee for association with the user information entry. The collected user information from the kiosk can be transmitted to a central server for managing information exchange, as explained in conjunction with FIG. 10, below.

Referring now to FIG. 7, an example embodiment of a data exchange system 345 is shown according to a possible embodiment of the present disclosure. In certain embodiments, the data exchange system 345 is positioned at an exhibitor location 340 in the example event environment 300, as described above. In further embodiments, the data exchange system 345 can be positioned elsewhere within an event's exhibit hall or other location, and can be configured to display advertisements, such as incentives, drawings, or other advertisements that are unaffiliated with any of the exhibitor locations.

In certain embodiments, the data exchange system 345 includes a computing device 700 and a communication unit 705 that resembles a small surveillance camera. In one aspect, the communication unit 705 is coupled to a metal frame housing 710 along with a display screen 715 that can, for example, display example exhibitor literature to event participants. In other embodiments, the communication unit 705 is utilized as a stand alone device, independent of the metal frame housing 710.

In general, the computing device 700 and the communication unit 705 are communicatively interconnected. In one aspect, a main line voltage transformer 720 serves as an intermediary connection between the computing device 700 and the communication unit 705. The main line voltage transformer 720 includes a first USB port 725, a second USB port 730, and a power cable 735. In the example embodiment, a non-powered USB cable 740 is connected between the computing device 700 and the first USB port 725, and a powered USB cable 745 is connected between the second USB port 730 and the communication unit 705. In this manner, the main line voltage transformer 720 provides power for the communication unit 705 and passes a communication signal between the computing device 700 and the communication unit 705 via USB connection. In an alternative embodiment, a single USB cable is connected between the computing device 700 and the communication unit 705 such that power to the communication unit 705 is configured to be drawn from the computing device 700. In still further embodiments, the communication unit 705 may be powered by a portable power supply such as disposable or non-disposable batteries.

In example embodiments, the communication unit 705 is configured to exchange contact and media information with a personal communication unit (PCD) via infrared or other optical communications, as described above. In the example embodiment, an infrared communications aperture 750 incorporated into the communication unit 705 is configured to convey and receive an infrared signal. In certain embodiments, the transmission and reception functionality of the communication unit 705 is controlled by the computing device 700 running an instance of a Web-based software application.

In certain embodiments, the metal frame housing 710 is mounted on a portion of a structure at the exhibitor location 340, such as a frame (e.g. a stand useable for advertising), with the infrared communications aperture 750 optimally orientated to control a line of sight such that all generated infrared signals in the example event environment 300 does not disrupt communication unit 705 operation. In other example embodiments, a blinding device (not shown) consisting of an optically opaque material can be retrofitted to the communication unit to control a line of site and block out undesired optical signals. The computing device 700 includes generalized computing capability, and can connect to remote systems (e.g. a server) via a communicative connection 755.

In an alternative arrangement of the data exchange system 345, the communication unit 705 can be mounted on the housing 710 of a display 715 that includes computing functionality (i.e. the display 715 is itself a computing system). In such an arrangement, the various connections to the computing system 700 and the main line transformer 720 are unnecessary, and the data exchange system 345 can be freestanding (e.g., only require a power connection). The display 715 can be a display device (e.g. LCD display) including a small form-factor computing device or other system capable of communicatively connecting to another device independently of a communications hub, such as the main line voltage transformer. The display 715, and integrated communication unit 705, thereby communicate directly via connection 755 to a remote server to exchange data (e.g. vCards, attendee identifiers, etc.) to be accessed and used via a Web application. Communicative connections can occur by RF, cellular, or other communications means, for transmitting advertisements or display literature to the display 715, while returning received PCD identifiers or vCard information from the display to a server. Furthermore, using the RF (e.g. WiFi, WiMax) or other wireless connection, each data exchange system can operate as a wireless hotspot for event attendees as well.

As mentioned above, in certain embodiments, the communication unit 705 can be utilized as a stand alone device, independent of any type of metal frame housing 710. Referring now to FIG. 8, in one embodiment, the communication unit 705 is mounted on a formable gooseneck clamp fixture 800 that includes a first end 805 having a first coupling 810 affixed thereto for coupling the gooseneck clamp fixture 800 to a feature on the exhibitor booth 340. The gooseneck clamp fixture 800 additionally includes a second end 815 having a second coupling 820 for coupling a communication unit 705 thereto. As described above, the infrared communications aperture 750 of the communication unit 705 is optimally orientated to control a line of sight such that all generated infrared or other optical signals in the event environment do not disrupt communication unit operation.

In certain embodiments, the communication unit 705 is mounted at an event location, e.g. at a booth or table and mounted at a height sufficient to allow line-of-sight infrared communications between the unit 705 and another system, such as a PCD, when a large number of attendees are present. In certain embodiments, the communication unit 705 is mounted at a height of between about 2 feet to about 14 feet above the event location's floor. In one possible embodiment, the communication unit 705 is mounted at a height of about 8 feet above the event location's floor. Alternatively, the communication unit 705 can be placed on a table, in a window of a house for sale, or other location where data exchange is likely to take place or otherwise desirable.

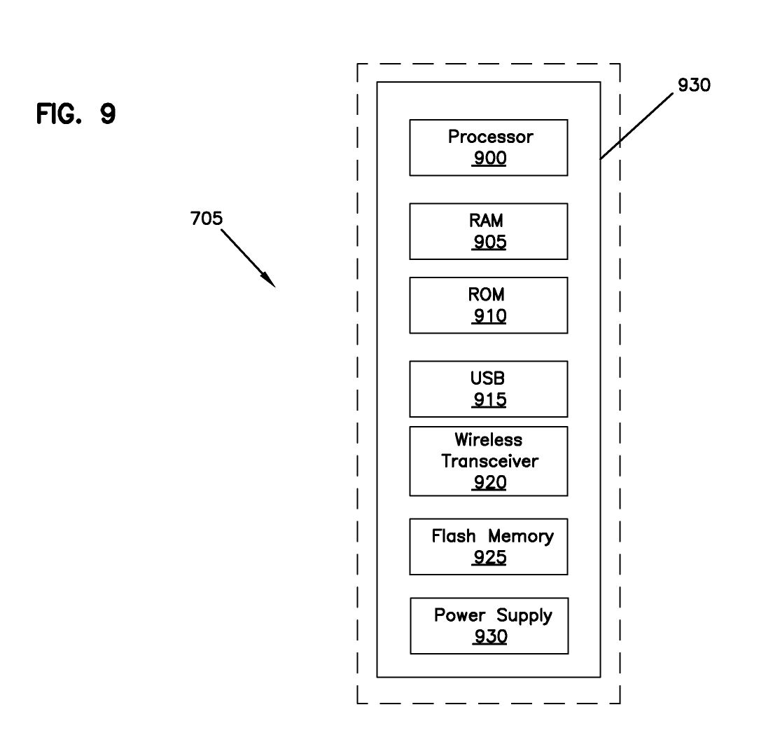

Referring now to FIG. 9, a block diagram of the communication unit 705 is depicted according to a possible embodiment of the present disclosure. In certain embodiments, the communication unit 705 includes a processor module 900, a RAM module 905, a ROM module 910, a USB communication module 915, a wireless communication module 920, and a flash memory module 925. In other embodiments, the communication unit 705 does not include the flash memory module 925. In one aspect, respective modules 900, 905, 910, 915, 920, and 925 are positioned on a printed circuit board (PCB) 930 that generally includes supporting electronic circuitry to enable the communication unit 705 to exchange information with other various compatibly configured computing devices, as described above. In certain embodiments, the communication unit 705 includes a power source 930, which corresponds to a power/data connection to a computing system, such as a USB interface. In alternative embodiments in which the communication unit 705 connects to a computing system via a non-powered interface, the communication unit can be powered by batteries, such as rechargeable batteries, or configured with an alternative power supply such as a solar cell.

In use, the communication unit 705 is generally configured to collect information from various attendee PCDs, as each attendee passes by the event exhibitor location and opts to activate their PCD. The attendee PCDs exchange information with the communication unit 705, which is periodically polled by the computing device 700 to obtain attendee information. The computing device 700 can then optionally display a portion of this information, e.g. the attendee's name and/or picture, and other exchanged information. This displayed information can be received from the PCD, or, in certain embodiments in which the computing device is connected to a database of attendee records (e.g. the database 1015 of FIG. 10, below), the computing device can access attendee information on that database based on a reference identifier received from the PCD. The information displayed to the exhibitor can be used to assist interaction with the attendee by providing personal information (e.g. the name, digital photograph, or other information) of the attendee to the exhibitor to facilitate a conversation.

### C. Data/Literature Storage, Access, and Usage

Referring now to FIGS. 10-15, various systems and user interfaces are disclosed which allow access to user contact information and literature distributed via the systems and methods disclosed above in FIGS. 1-9. In the context of a trade show, the systems and interfaces disclosed below provide a scheme for trade show attendees to paperlessly receive product and contact information, and for trade show exhibitors to receive contact information from the attendees (e.g. potential customers or business partners) for use both at the trade show and afterward for follow-up contacts. In the context of an open house or other sale of real estate, the systems and interfaces disclosed provide a scheme for those attendees (e.g. property visitors) to paperlessly receive property information and provide contact information to a realtor for follow-up contact. Other event contexts can implement the systems and interfaces of FIGS. 10-15 as well to accomplish paperless communication of contacts and literature to facilitate data exchange between interested parties to an event.

Now referring to FIG. 10, an exemplary communications network 1000 is shown in which aspects of the present disclosure can be implemented. More specifically, network 1000 includes the initialization device 330 and a data exchange system 345 as described with reference to FIGS. 1-9. Network 1000 additionally depicts an attendee personal computing device 1005. In the example embodiment, the initialization device 330 (e.g. the kiosk of FIG. 6) and data exchange system 345 include a general purpose computing device 1010 embodying the functionality of a computing device as described with reference to each of the respective elements 330, 345, above.

In the example embodiment, respective elements 330, 345 are configured to have a communication network access capability (e.g., the Internet), and are provided with an instance of a dedicated event Web-based software application. In one aspect, the software application enables the respective computing devices 1005, 1010 to communicate with a database 1015 containing event related media and contact information via a bidirectional communication link 1020 over a communication network 1025. In general, the information in the database 1015 is accessed and controlled by one or more dedicated database servers 1030.

In certain embodiments, an exhibitor, advertiser, or attendee is allocated a memory space 1035 in the database 1015 for storing a plurality of records 1040. In one aspect, the plurality of records 1040 containing Internet address links to exhibitor specific media, as described above. In one embodiment, a master link 1045 is assigned to specify the location of the memory space 1035 with respect to a particular exhibitor, attendee, or advertiser. In certain embodiments, the master link 1045 contains information about the location of the first record of plurality of records 1040 and the total number of the plurality of records 1040. In this manner, upon attendee selection of the master link 1045 the database server can implement an algorithm to download the entire content of the plurality of records 1040 associated with that exhibitor, attendee, or advertiser.

In one example embodiment utilizing two-way communication between the PCD 310 and communication unit 705, the master link 1045 is initially transferred from the database 1015 to the communication unit 705 of the data exchange system 345 for distribution to attendee PCDs 310, as described above. In this manner, only a single link is required to be stored on memory element in the communication unit 705, thereby minimizing the duration of a PCD-communication unit information exchange.

In further embodiments, an exhibitor contact memory space 1050 in the database is allocated to an exhibitor that contains a plurality of attendee contact records 1055 as obtained in a PCD-communication unit information exchange, described above. The attendee contact records 1055 can be, in various embodiments, full contact records, such as vCards or other contact cards, or can alternatively include links to attendee information stored elsewhere (e.g. in the database 1015 associated with a particular attendee).

In the described embodiments, the Web-based software application enables the management and organization of the plurality of attendee contact records 1055. In general, an exhibitor can access and manipulate the data in the respective memory spaces 1035, 1050 via the Web-based software application as running on computing device 1010. However, in example embodiments, the database server 1030 hosts a Web portal such that an exhibitor can securely log-on and access the data via any computing device having network access capability.

In certain embodiments, an attendee is allocated an attendee memory space 1060 in the database 1015 for storing a plurality of media records 1065 containing links to or copies of the master links of exhibitor information, or other content such as website links, product literature, promotional materials, or any other type of media as acquired at an event, as described above. In further embodiments, an attendee contact memory space 1070 in the database is allocated to the attendee that contains a plurality of contact records 1075 as obtained in either a PCD-communication unit information exchange or a PCD-PCD information exchange, as described above. In the example embodiments, the attendee may utilize the Web-based software application running on the attendee personal computer 1005 to manage and organize the plurality of media records 1065 attendee and contact records 1075 in respective memory spaces, 1060, 1070. However, in certain embodiments, the database server 1015 hosts a Web portal such that an attendee can securely log-on and access the data via any computing device having network access capability.

In certain other embodiments, a unique set of memory locations in the database 1015 is allocated for a participating event attendee for each respective event and maintained for a period of time following the end of the event. In one example embodiment, the set of memory locations in the database 1015 is maintained between about 1 month and 12 months following the event. In a further embodiment, the set of memory locations in the database 1015 is maintained for about 6 months. In still further embodiments, users of the database can request maintenance of the database for additional periods of time through payment of fees.

In use, the database server 1030 receives associations between event attendees and exhibitors from the exhibitors' data exchange devices. These associations can take a variety of forms, based upon the particular data exchange process performed. For example, in instances where two-way communication of data between a PCD and data exchange device is performed, an event exhibitor can send the attendee contact information to the database server from the data exchange devices associated with that exhibitor. The database server 1030 will recognize the source of the contact information, and associate it with that exhibitor by storing the contact in memory space 1050. The database server 1030 can also store in the attendee memory space 1060 a media record 1056 (e.g. a master link to the exhibitor materials, or the materials themselves). Alternatively, the database server 1030 stores the media record 1065 associated with the exhibitor (e.g. the master link to exhibitor materials) in the attendee memory space 1060 upon the attendee logging in and providing to the database one or more master links received on a PCD from the exhibitor.

In an alternative embodiment where one-way communication of data between a PCD and data exchange device occurs, the exhibitor sends the attendee identifier to the database server 1030. In this situation, the attendee identifier is linked to the exhibitor identifier by way of being received from the exhibitor at the database 1015. The database server 1030 then stores attendee information in the exhibitor's memory space 1050, and media records (e.g. links or content) 1065 in the attendee memory space 1060. Furthermore, exchanged contact information can be distributed to memory space 1070 of the respective attendees.

When an exhibitor, attendee, or other individual wishes to access information gathered at an event (e.g. literature or contacts in the case of an attendee or contacts in the case of an exhibitor or advertiser), that individual can access a Web-based software application to view the gathered information. When an attendee accesses such information, memory spaces 1060 and 1070 can be accessed to display contacts and literature collected by that attendee. When an exhibitor or advertiser accesses such information, memory spaces 1035 and 1050 are accessed to display the literature that they have provided, as well as contact information collected (e.g. by resolving the links in the database 1015 to attendee records).

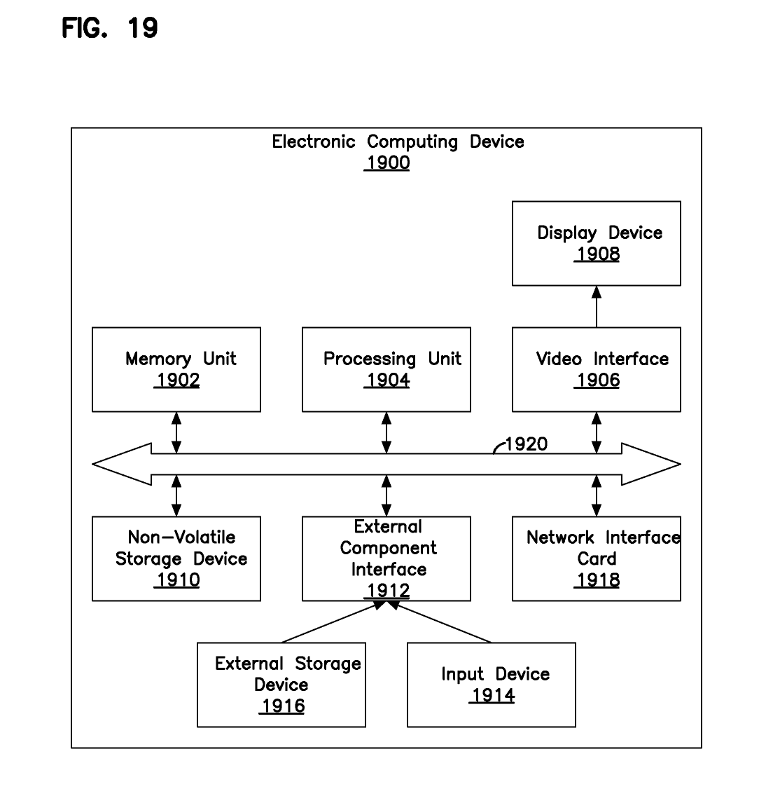

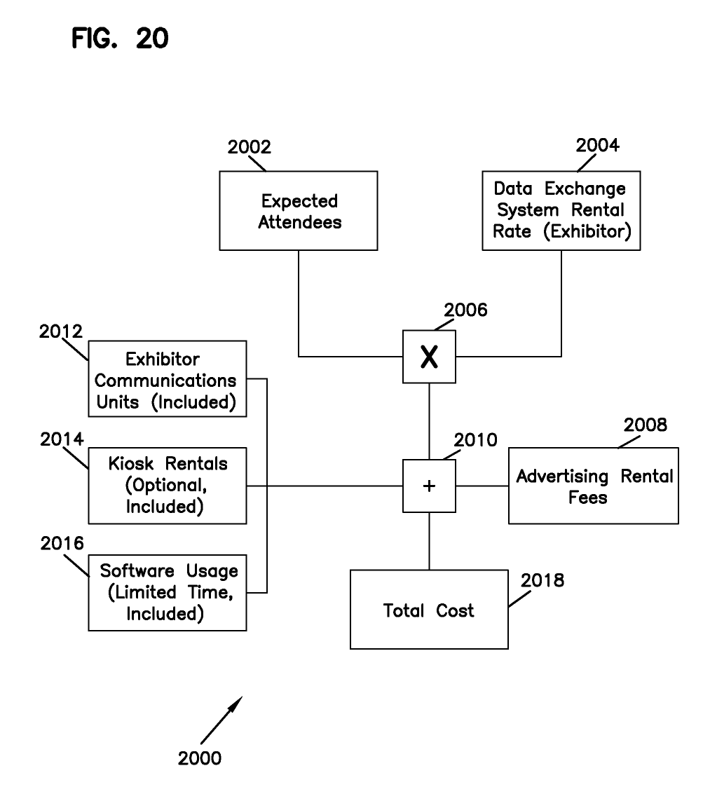

In connection with access of gathered information, in some embodiments, the memory space 1035 is associated with access history information about individuals who have accessed certain content using the user interfaces and methods described herein. This history information can be stored in the database 1015 or a separate database, and can include the name of the accessing entity, an identifier of the accessed information, an amount of time the information was accessed, and the exhibitor associated with the accessed information. Other historical information can be tracked as well. The history information can, in certain embodiments, be used in connection with other stored data to perform a number of operations, including monitoring usage of data by attendees and exhibitors (and therefore extracting a position of the attendees in relationship to the exhibitor booths, for example) or qualifying potential sales leads as described in FIGS. 19-20, below.

Although in FIG. 10 the network 1000 is described as used by an event attendee and exhibitor in certain examples, it is understood that the exhibitor could be any of a number of other entities that wish to distribute information to event attendees, such as advertisers or other individual attendees.

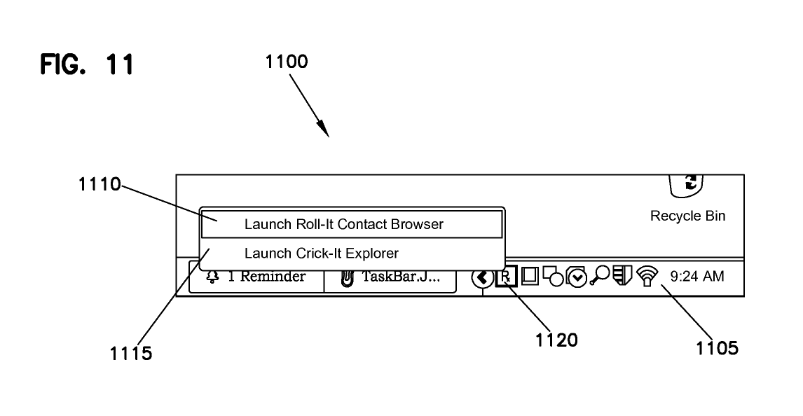

Referring now to FIGS. 11-16, several example screenshots of an example interface to a Web-based software application according to the principles of the present disclosure is shown. In general, an instance of the Web-based software application is running on elements 1005 and 1010 as depicted in FIG. 10.

FIG. 11 is a screenshot 1100 of an example tray 1105 demonstrating a feature to launch an instance of Web-based software application. In certain embodiments, a contacts browser module 1110 and an explorer module 1115 can be launched from an icon 1120 on the tray 1105. In certain embodiments, an action of launching the contacts browser module 1110 generates a Web page that renders a consolidated and organized list of user contacts. Additionally, in certain embodiments, an action of launching the explorer module 1115 generates an interface such that locally stored media and contact information is accessible.

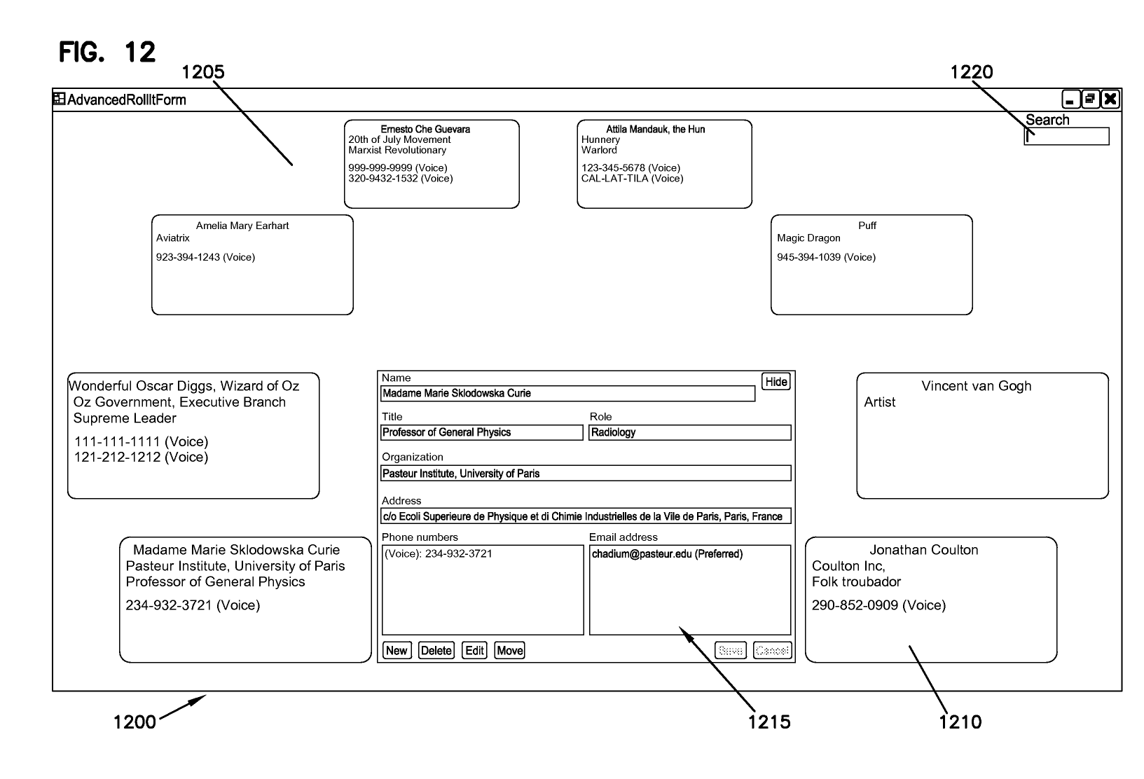

Referring now to FIG. 12, a screenshot 1200 of an example contact management user interface 1205 is shown. In certain embodiments, user interface 1205 is accessed via launching of browser module 1110 as shown in FIG. 11. In one example embodiment, vCard information is graphically rendered on user interface 1205 a business card 1210. In certain embodiments, a business card 1210 is graphically rendered on user interface 1205 in a circular format to represent a “rolodex” type format. For example, in certain embodiments, a plurality of business cards 1210 are stored alphabetically according to predefined criteria (i.e., Last Name). In certain embodiments, the “rolodex” as rendered on user interface 1205 is cyclically accessible such that respective business cards 1210 rotate to centrally present a specific business card 1210 as desired. In certain embodiments, a respective business card 1210 can be selected to open an edit contact information form 1215 as desired, described in further detail below. In certain embodiments, a search data field 1220 is provided such that a user can keyword search through available contacts.

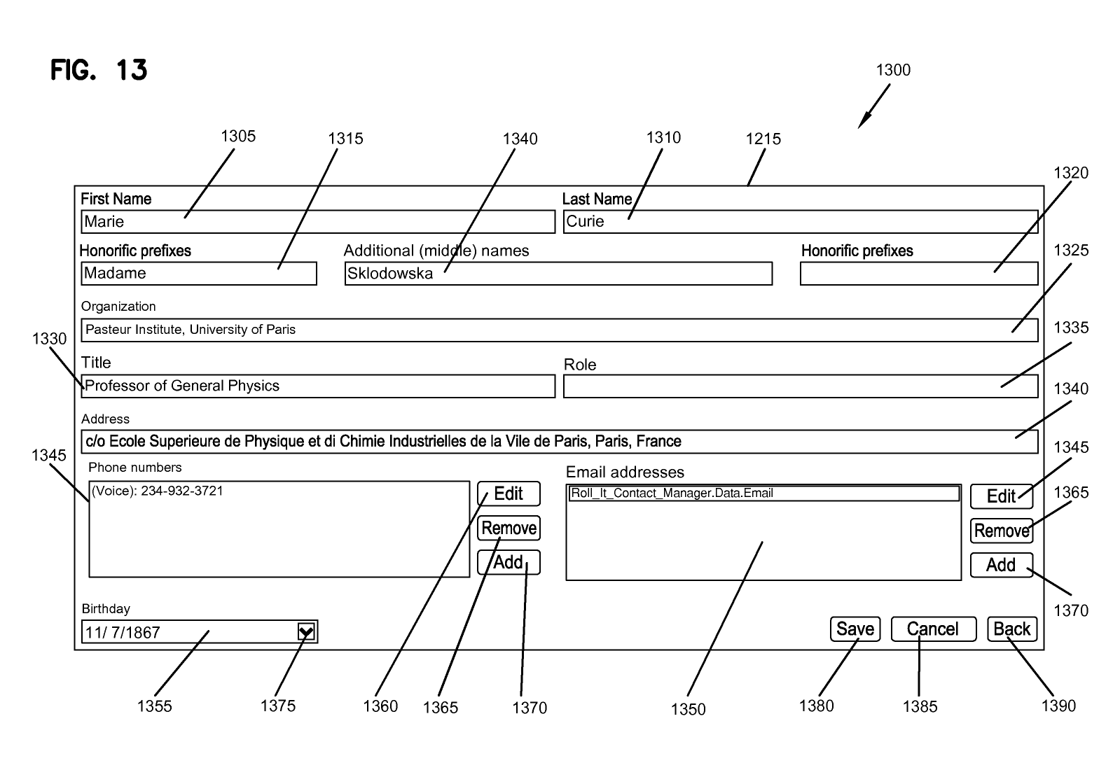

FIG. 13 depicts a user interface 1300 of one example contact information form 1215 as referred to in the description of FIG. 13. The contact user interface 1300 displays the various information related to a contact, such as an attendee at an event or an exhibitor at that event. The contact user interface 1300 displays contacts collected by a particular user (attendee or exhibitor), as indicated by the link information collected on a PCD or communication device at the event. As previously described, the event could be any of a number of events, such as a sale of a home (e.g. during an open house), a trade show, an exhibition, or other data/literature exchange or networking event.

In general, contact information form 1215 includes a plurality of data fields to contain contact information a respective participant of the example event environment 300 as shown in FIG. 3. In one example embodiment, the data fields include a First Name 1305 field, a Last Name 1310 field, an Honorific Prefix 1315 field, an Honorific Suffix 1320 field, an Organization 1325 field, a Title 1330 field, a Role 1335 field, an Address 1340 field, a Phone Number 1345 field, an Email Address 1350 field, and a Birth Date field 1355. Contact information form 1310 additionally includes a plurality of editing and processing features. For example, in one embodiment the Phone Numbers field 1345 and the Email Addresses field 1350 are editable via an Edit button 1360, a Remove button 1365 and an Add button 1370. The contact information form 1215 can additionally include one or more drop-down pick list buttons 1375. The contact information form 1215 can be saved with Save button 1380, data entry canceled with Cancel button 1385, or a different data entry form screen can be accessed with Back button 1390.

In embodiments in which an attendee only enters a portion of the information from the user interface 1300 into the record associated with their PCD at the event (i.e. via the kiosk), that user may be prompted prior to use of the systems and methods of FIGS. 10-15 to provide additional information into that user's personal form 1300 for storage in the database 1015 of FIG. 10. For example, the attendee may be sent a link to a web portal to the database 1015 that requires registration that would complete the fields presented in the user interface 1300. In this way, subsequent accesses of contact information by exhibitors can provide those exhibitors complete information about that attendee, even when that attendee did not originally enter complete personal information at the event.

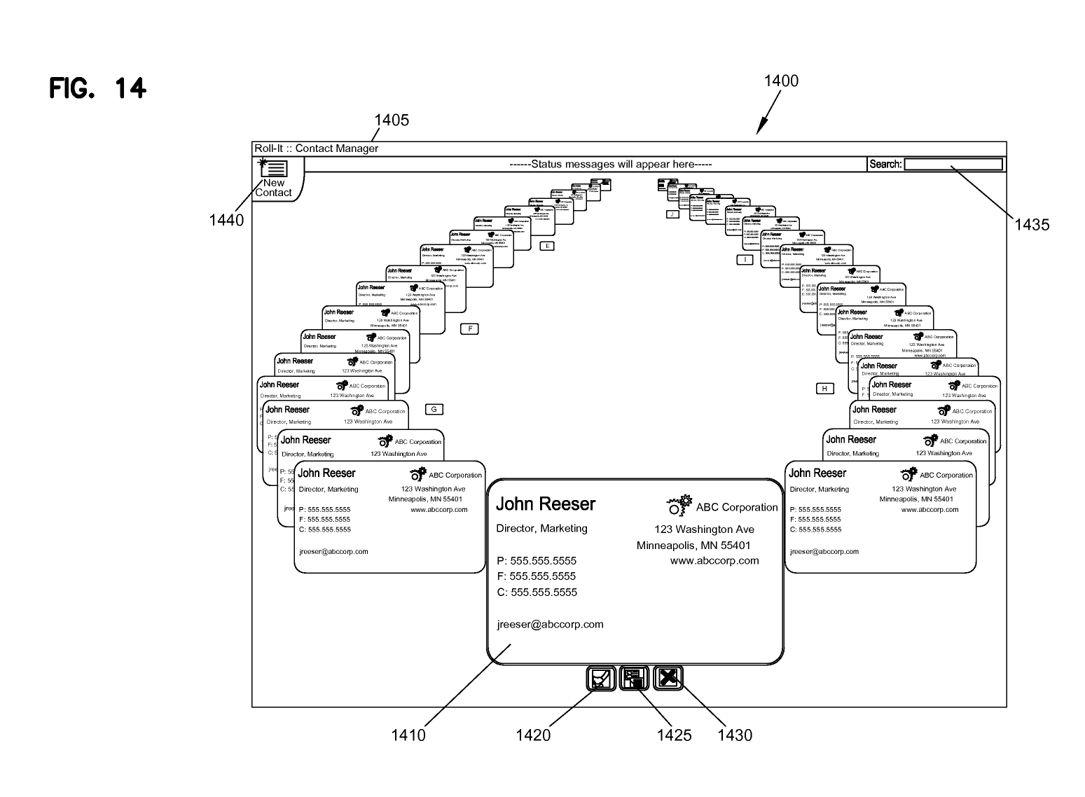

FIG. 14 depicts a screenshot 1400 of an alternate example of a contact management user interface 1405. In a similar manner as shown in the contact management user interface 1205 of FIG. 12, vCard information can be graphically depicted as a business card 1410 on the user interface 1405. In certain embodiments, the vCard contact information is graphically rendered on the user interface 1405 in a circular format to represent a “rolodex” type format. For example, in certain embodiments, a plurality of business cards 1410 are stored alphabetically according to predefined criteria (i.e., Business Name). In certain embodiments, the “rolodex” as rendered on user interface 1405 is cyclically accessible such that respective business cards 1410 rotate to centrally present a specific business card 1410 as desired. In certain embodiments, a business card 1410 can be selected to open an edit contact form 1415. In certain embodiments an edit button 1420, a cycle button 1425, and a delete button 1430 are provided to edit, cycle through or delete a contact record as desired. In certain embodiments, a search data field 1435 is provided such that a user can keyword search through available contacts. Further still, in certain embodiments, a new contact button 1440 is provided such that a user can manual enter a new contact's information.

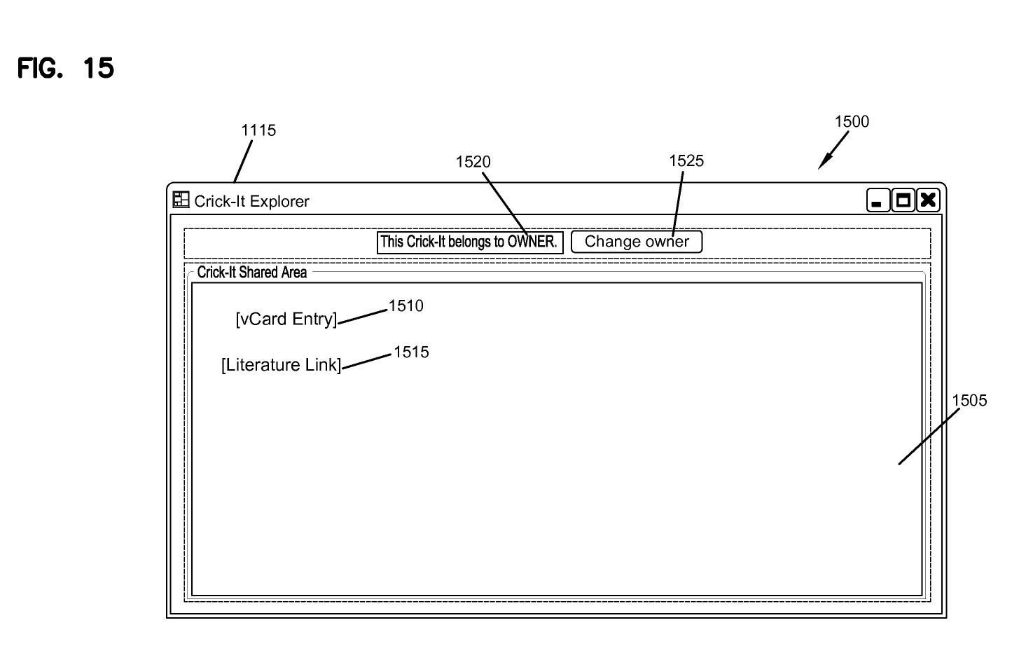

FIG. 15 depicts a user interface 1500 running an instance of explorer module 1115 as described above with reference to FIG. 11. In certain embodiments the explorer module 1115 is an interface that provides access to locally stored media and contact information via shared area 1505. In certain embodiments, explorer module 1115 additionally provides access to media and contact information as stored on a respective personal communication device (PCD), such as for example when a PCD is positioned in an infrared holster or connected via USB connection, as described above. In other embodiments, this information is retrieved from database 1015 upon logging in to the Web application, thereby eliminating the need for a PCD interface on the computing system, or other PCD-to-PC connection.

In the described embodiment, the media and contact information is displayed in the shared area 1505. For example, a specified vCard entry 1510 and literature link 1515 can be displayed in shared area 1505, among a plurality of other possible media and contact information. Further, a PCD can be assigned an owner 1520 (or owner information can be edited) with button 1525.

The user interfaces of FIGS. 12-15 can include a number of additional features as well, such as fields available to display advertisements to the user. These advertisements, can for example, include context-specific advertisements related to the product literature or contact being viewed. Other possibilities exist as well.

Using the systems and user interfaces of FIGS. 10-15, event attendees and exhibitors can be provided with access to and management of both contacts and literature related to those contacts. For example, an event attendee can collect contact information from a number of exhibitors, alongside which that attendee may be sent a packaged link to additional product literature or other information via the master link received on that attendee's PCD. Or the attendee can view information related to advertising, drawings, or sweepstakes that the attendee elected to enter or select by activating their PCD toward that particular data exchange device 345. Similarly, an event exhibitor can receive contact information related to that event's attendees, such that the exhibitor can follow up with those attendees following the event, with respect to informational or sale information, or other reasons. Additional details regarding qualifying these contacts (e.g., determining whether the contacts are worth pursuing) are described below in conjunction with FIGS. 20-22.

It is further noted, that using the systems and methods of FIGS. 10-15, users such as event attendees and exhibitors may update their personal information or literature after an event or other information exchange event occurred. These changes to user information are propagated back to the database 1015, and allow other users who previously exchanged information with that user to view updated information about the user after they have updated their information. By providing this central repository of real-time accurate information related to event attendees and exhibitors, the information does not become stale (e.g. as individuals change companies or product literature changes) even after the event has occurred. This allows exhibitors and attendees to provide persistent, up-to-date literature and contact information availability.

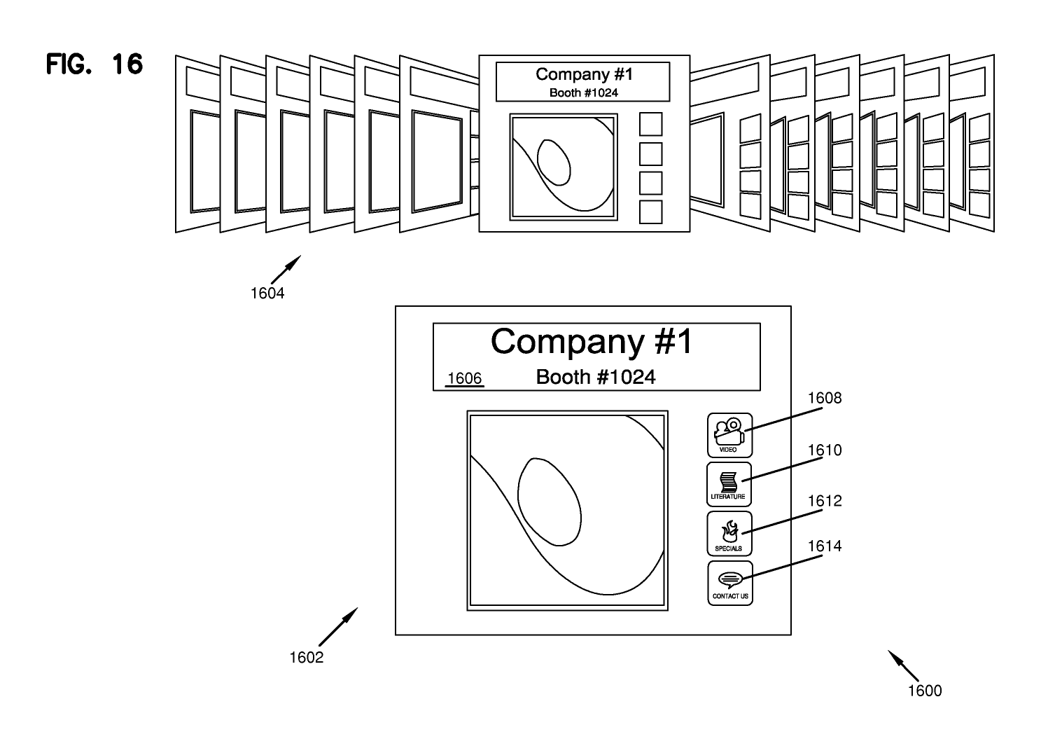

FIG. 16 displays an example user interface 1600 useable for information and literature management. The user interface 1600 can be used in place of or addition to the interfaces of FIGS. 12 and 14, and can be used for management of contact information, literature, and associated information related to trade show exhibitors, advertisers, or other individuals having exchanged contact information. The user interface 1600 can be presented to any of a number of users over a standard computer network as described herein.

The user interface 1600 generally provides a “cover flow” style interface, including a currently selected entity 1602 (e.g., exhibitor, advertiser, or individual) and a browseable flow graphic 1604 allowing navigation through the loaded entities. The currently selected entity 1602 is illustrated as reproduced in a larger format than in the browseable flow graphic 1604, and includes additional details. In the embodiment shown, the currently selected entity includes a display area that includes graphical and textual content, as well as a video button 1608, a literature button 1610, a specials button 1612, and a contact button 1614. The video button links to informational videos regarding the selected entity; the literature button 1610 launches a further user interface capable of accessing literature provided by the entity as previously described. The specials button 1612 allows particular news regarding products or services to be communicated to the user. The contact button can either lead to a user form for contacting the entity, or can display contact information for that entity, for example using the user interfaces described above.

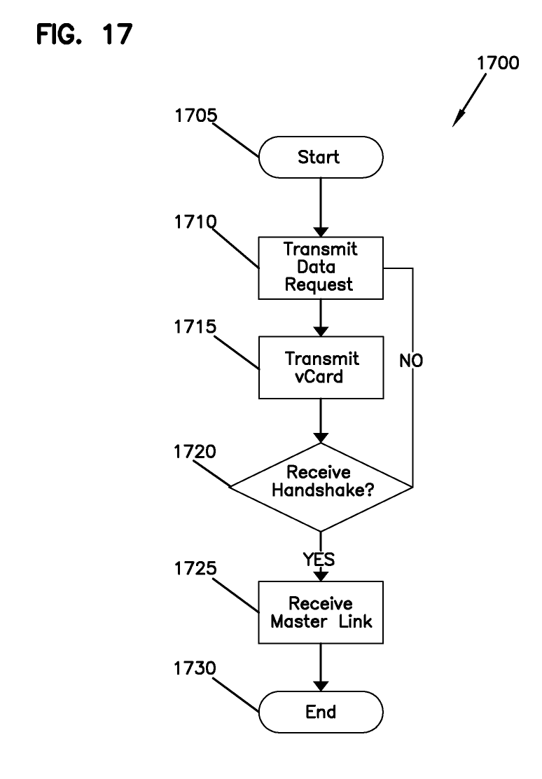

Referring now to FIG. 17, methods and systems for data transfer are shown according to a possible embodiment of the present disclosure. The disclosed methods and systems can be embodied as a wireless data transfer between an attendee personal communication device and an exhibitor communication unit as described with reference FIGS. 1-16 above. In one example embodiment system 1700 as disclosed is performed within an attendee personal communication device.

The system 1700 is instantiated at a start module 1705. Operational flow proceeds to a transmit data request module 1710. The transmit data request module 1710 sends a data transaction request to an exhibitor communication unit via a bidirectional communication link. In certain embodiments, the communication link can be a modulated infrared signal transmitted through the air. In other embodiments, a direct wired or a radio frequency communication can be employed. In certain embodiments, the infrared signal contains additional information including such as an identifier that uniquely identifies the requesting personal communication device.

Operational flow proceeds to a transmit data module 1720. The transmit data module 1720 executes the transmission of data to the exhibitor communication unit. In certain embodiments, the data transfer includes attendee contact information, as described above. In alternative embodiments, the data transfer includes transfer of a link to an attendee record. In certain embodiments, the transmit data module 1720 implements a communications protocol that modulates an infrared signal to encode the contact information into the infrared signal. Other information can be encoded into the infrared signal as desired. In certain embodiments, the transmit data module 1720 executes concurrently with the transmit data request module, with the transmitted data also acting as a request to instantiate a communications session with another device. Other arrangements employ multiple data transmissions.

Operational flow proceeds to a handshake module 1715. The handshake module 1715 receives an acknowledgment from the exhibitor communication unit indicating that the requested data transaction as sent via transmit data request module 1710 was successful. If the acknowledgement is not received and the handshake operation does not occur, operational flow branches “NO” to return to the transmit data request module 1710, to retry establishing the data communications connection.

If the acknowledgement is received successfully, operational flow branches “YES” and proceeds to receive data module 1725. In certain embodiments the receive data module 1725 receives a modulated infrared signal from the communication unit. In certain embodiments, receive data module 1725 implements a communications protocol that demodulates the received infrared signal to convert the signal into a digital electrical signal representing exhibitor specific information. In certain embodiments, the demodulated digital electrical signal is stored in a predetermined format in a memory element such as a flash memory or other persistent memory in which electronic data is saved. In certain embodiments, the information includes a master link to represent a path to the group of Internet address links of pointing towards exhibitor media or exhibitor contact information, as described above.

Operational flow terminates at an end module 1730, which corresponds to a successful data transfer between an attendee personal communication device and an exhibitor communication unit.

In embodiments implementing one-way communication, the system 1700 may optionally terminate after operation of the transmit data module. In such embodiments, the attendee's PCD and the exhibitor communication unit do not perform a handshaking operation. Therefore, in such embodiments a visual or audible cue can be presented to a user to indicate that the transmission of an identifier of that user was successful, such as by flashing a display screen associated with the exhibitor communication unit. For example, a display of a data exchange device (e.g. the device of FIG. 7, above) could flash to indicate the receipt of an identifier from a user.

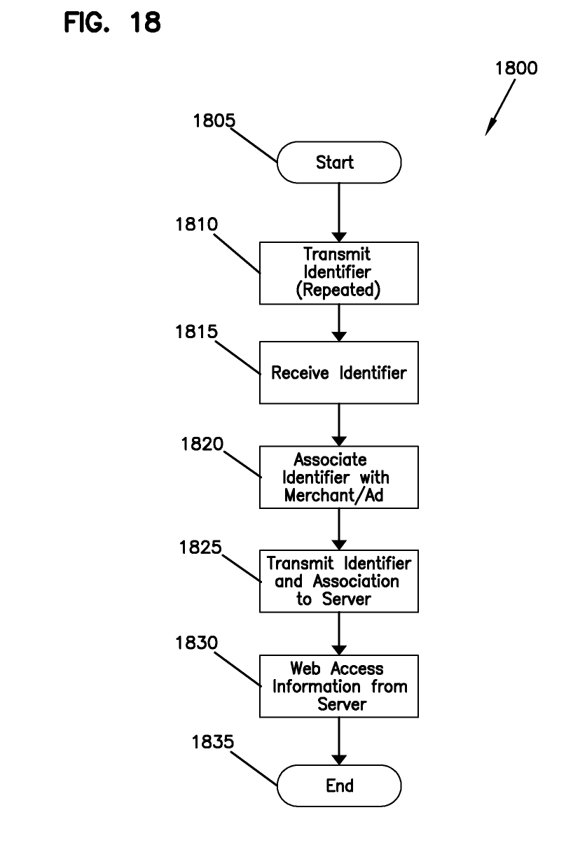

FIG. 18 illustrates an alternative method for data transfer, useable in embodiments in which one way communications from a PCD to a data exchange device is implemented. The disclosed methods and systems can also be embodied as a wireless data transfer between an attendee personal communication device and an exhibitor communication unit as described with reference FIGS. 1-15 above. In the example embodiment system 1800 as disclosed is performed using an attendee personal communication device and data exchange device.

The system 1800 is instantiated at a start operation 1805. Operational flow proceeds to a transmission module 1810, which transmits an identifier of the PCD to a data exchange device. A receive identifier module 1815 operates within the data exchange device to receive the personal identifier on behalf of the event exhibitor, the advertiser, or other entity associated with the data exchange device. The receive identifier module 1815 can optionally include presenting to the attendee some feedback indicating successful receipt of data, such as by causing a display to flash or emitting a feedback sound audible to the user. An association module 1820 associates the received identifier of the attendee with an identifier of the exhibitor, advertiser, or other attendee or entity. In a further embodiment, the association module 1820 associates the identifier received from the PCD with the literature, contact information, or advertisement selected by the exhibitor, advertiser, or other entity.

A transmission module 1825 transmits the identifier and associated exhibitor identifier (or literature) to a remote computing system, such as a remote server (e.g. server 1030 of FIG. 10). At that remote server, the link between the attendee and exhibitor (or advertiser or other attendee) is stored. An access module 1830 allows the attendee to access literature provided by the exhibitor or advertiser. The access module 1830 also allows the exhibitor or advertiser to access information about that user and other users accessing that exhibitor or advertiser. The system 1800 is completed at end operation 1835.

Upon completion of the system 1800, a user can continue to access information from the event exhibitor or advertiser, and can be contacted by either of those entities as desired. For example, an event exhibitor can send to the attendee information about new or different literature available from the exhibitor via the Web application. Or, an advertiser can notify a winner of a drawing or sweepstakes held by that advertiser in conjunction with the event. Other possibilities exist as well.

FIG. 19 is a block diagram illustrating example physical components of an electronic computing device 1900, which can be used to execute the various operations described above, and can be any of a number of the server systems or other computing devices described above as capable of hosting data related to electronic contacts and literature, or for user access to such a database. A computing device, such as electronic computing device 1900, typically includes at least some form of computer-readable media. Computer readable media can be any available media that can be accessed by the electronic computing device 1900. By way of example, and not limitation, computer-readable media might comprise computer storage media and communication media.

As illustrated in the example of FIG. 19, electronic computing device 1900 comprises a memory unit 1902. Memory unit 1902 is a computer-readable data storage medium capable of storing data and/or instructions. Memory unit 1902 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 1900 comprises a processing unit 1904. As mentioned above, a processing unit is a set of one or more physical electronic integrated circuits that are capable of executing instructions. In a first example, processing unit 1904 may execute software instructions that cause electronic computing device 1900 to provide specific functionality. In this first example, processing unit 1904 may be implemented as one or more processing cores and/or as one or more separate microprocessors. For instance, in this first example, processing unit 1904 may be implemented as one or more Intel Core 2 microprocessors. Processing unit 1904 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 1904 may be implemented as an ASIC that provides specific functionality. In a third example, processing unit 1904 may provide specific functionality by using an ASIC and by executing software instructions.

Electronic computing device 1900 also comprises a video interface 1906. Video interface 1906 enables electronic computing device 1900 to output video information to a display device 1908. Display device 1908 may be a variety of different types of display devices. For instance, display device 1908 may be a cathode-ray tube display, an LCD display panel, a plasma screen display panel, a touch-sensitive display panel, a LED array, or another type of display device.

In addition, electronic computing device 1900 includes a non-volatile storage device 1910. Non-volatile storage device 1910 is a computer-readable data storage medium that is capable of storing data and/or instructions. Non-volatile storage device 1910 may be a variety of different types of non-volatile storage devices. For example, non-volatile storage device 1910 may be one or more hard disk drives, magnetic tape drives, CD-ROM drives, DVD-ROM drives, Blu-Ray disc drives, or other types of non-volatile storage devices.

Electronic computing device 1900 also includes an external component interface 1912 that enables electronic computing device 1900 to communicate with external components. As illustrated in the example of FIG. 19, external component interface 1912 enables electronic computing device 1900 to communicate with an input device 1914 and an external storage device 1916. In one implementation of electronic computing device 1900, external component interface 1912 is a Universal Serial Bus (USB) interface. In other implementations of electronic computing device 1900, electronic computing device 1900 may include another type of interface that enables electronic computing device 1900 to communicate with input devices and/or output devices. For instance, electronic computing device 1900 may include a PS/2 interface. Input device 1914 may be a variety of different types of devices including, but not limited to, keyboards, mice, trackballs, stylus input devices, touch pads, touch-sensitive display screens, or other types of input devices. External storage device 1916 may be a variety of different types of computer-readable data storage media including magnetic tape, flash memory modules, magnetic disk drives, optical disc drives, and other computer-readable data storage media.

In the context of the electronic computing device 1900, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 1902, non-volatile storage device 1910, or external storage device 1916, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 1900.

In addition, electronic computing device 1900 includes a network interface card 1918 that enables electronic computing device 1900 to send data to and receive data from an electronic communication network. Network interface card 1918 may be a variety of different types of network interface. For example, network interface card 1918 may be an Ethernet interface, a token-ring network interface, a fiber optic network interface, a wireless network interface (e.g., WiFi, WiMax, etc.), or another type of network interface.

Electronic computing device 1900 also includes a communications medium 1920. Communications medium 1920 facilitates communication among the various components of electronic computing device 1900. Communications medium 1920 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 1920, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 1900 includes several computer-readable data storage media (i.e., memory unit 1902, non-volatile storage device 1910, and external storage device 1916). Together, these computer-readable storage media may constitute a single data storage system. As discussed above, a data storage system is a set of one or more computer-readable data storage mediums. This data storage system may store instructions executable by processing unit 1904. Activities described in the above description may result from the execution of the instructions stored on this data storage system. Thus, when this description says that a particular logical module performs a particular activity, such a statement may be interpreted to mean that instructions of the logical module, when executed by processing unit 1904, cause electronic computing device 1900 to perform the activity. In other words, when this description says that a particular logical module performs a particular activity, a reader may interpret such a statement to mean that the instructions configure electronic computing device 1900 such that electronic computing device 1900 performs the particular activity.

One of ordinary skill in the art will recognize that additional components, peripheral devices, communications interconnections and similar additional functionality may also be included within the electronic computing device 1900 without departing from the spirit and scope of the present invention as recited within the attached claims.

### D. Additional Features of the Electronic Literature Distribution System

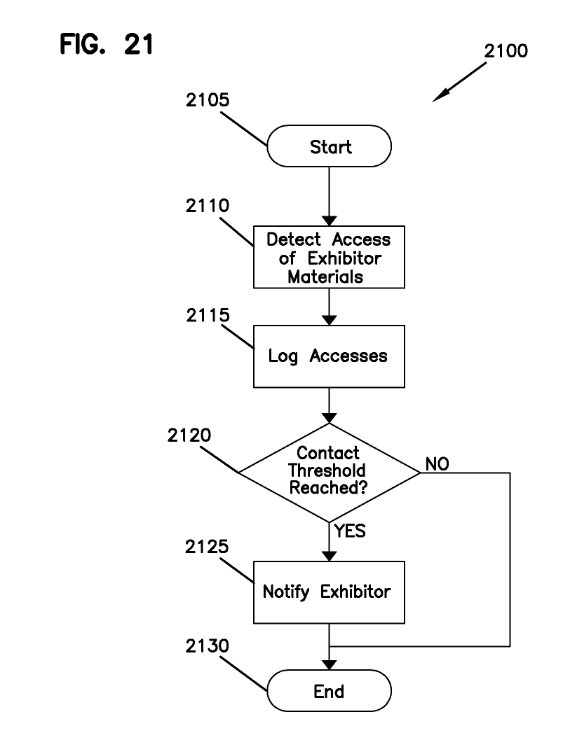

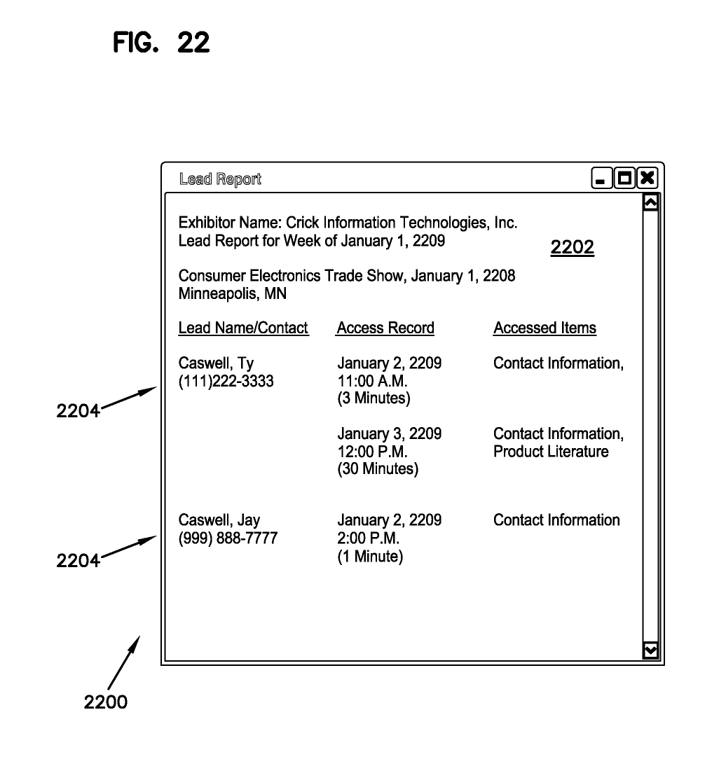

Referring now to FIGS. 20-22, additional features of the electronic literature distribution system are described. FIG. 20 provides an example detailing expense distribution for the systems described herein which provides a framework for cost savings over traditional printed materials in the context of an event environment, such as a trade show, open house, or other meeting environment. FIGS. 21-22 illustrate features for qualifying contact leads for exhibitors using the devices and computing infrastructure described herein.

FIG. 20 illustrates methods and systems for electing and distributing expenses within an event environment, such that the costs are apportioned to entities willing to pay for attendance at the event, and cost savings are realized among all parties attending the event. Specifically, FIG. 20 shows a block diagram of a cost apportionment system 2000 that illustrates charging event exhibitors and advertisers for attendance at the event, by a lessor of equipment to be used in the system, as previously described. These entities traditionally bear the majority of costs of attending an event. Due to the potential for increased business contacts through use of the systems and methods of the present disclosure, these entities can consequently also bear the costs of the system disclosed herein.

In the embodiment shown, an expected attendees variable 2002 and a data exchange system rental rate 2004 are multiplied at operation 2006 to determine a charge to be assessed to the event exhibitor. In certain embodiments, each data exchange system be rented at this rate; however, in other embodiments, this rate can represent a total cost to an exhibitor to be outfitted with a sufficient number of data exchange systems for making attendee contacts. Preferably, the cost of the data exchange system rental rate is lower, per attendee, than the cost of preparing printed materials for the same number of expected attendees (i.e. attendees 2002), thereby improving the cost efficiency of the system 2000 over existing systems from the exhibitor's perspective. In one such embodiment, each exhibitor is charged this multiplied cost, and based on current printing costs are able to save money on materials distribution after being charged, for example, about $0.17 per expected event attendee. This cost may vary, depending upon the typical printing cost of materials to be distributed at the event.

The costs charged to the exhibitor are added to any advertising rental fees 2008 at operation 2010. The advertising rental fees can be charged as a flat fee per data exchange device (as shown), or per a number of expected exhibitors, or on some other basis. The total fee to be charged to the advertiser for rental and use of the data exchange system is set such that it does not exceed the cost of traditional print advertising and user interaction/demographic collection charges.

Additional equipment that is required for the event site, including exhibitor communications units, a programming system such as a kiosk, or software to be used by any of the attendees, exhibitors, or advertisers can be included at no charge or minimal charge as well (indicated in charges 2012, 2014, and 2016, respectively included at operation 2010). A total cost 2018 can then be collected by the lessor of the equipment, with the total cost being lower than the total printing and advertising costs typically incurred by exhibitors and advertisers at events, while concurrently enhancing the experience for attendees, exhibitors, and advertisers alike (e.g. by providing easier interaction between these groups and by allowing up-to-date, organized, convenient information and literature exchange between the parties).

Referring now to FIGS. 20-22, additional features of the methods and systems for electronic literature distribution are described, relating to data processing operations following an event that provide automatic lead qualification to exhibitors or other sales companies involved in an electronic literature distribution transaction. FIG. 21 illustrates an example process 2100 for automatic qualification of leads, allowing the methods and systems herein to assess the quality of possible sales leads based on contacts between event attendees and exhibitors. Traditionally, in the context of a trade show or open house, exhibitors perform a triage process to assess the seriousness of an attendee as a potential customer, but do not receive any further feedback from that attendee after the event. Using the databases, data records, software, and user interfaces described above in FIGS. 10-15, post-event feedback can be automatically accumulated and provided to exhibitors indicating the level of interest of particular attendees in the products and services provided by that exhibitor. Through operation of this process, exhibitors are generated an indication of an efficient set of attendees to contact following an event based on that attendee's demonstrated interest.

The process 2100 is instantiated at a start operation 2105, which refers to establishment of an exhibitor memory space and providing electronic literature and/or contact information associated with that exhibitor in a database, such as described above with respect to FIG. 10. For example, the start operation 2105 can include an overall data exchange, such as can occur at a trade show, open house, or other event as described herein. Operational flow proceeds to a detection module 2110, which corresponds to detection of access of the electronic content by an attendee of the event, after an event at which electronic data records were exchanged. Specifically, the detection module 2110 can monitor access of centrally-stored content provided by the exhibitor for attendee access during or after the event. The detection module 2110 can detect any of a number of occurrences with respect to content access, such as the time the content is accessed, the duration of the access, the identity of the individual or organization accessing the content, and the specific content being accessed. A log module 2115 logs the accesses detected by the detection module 2110, and stores information associated with the content accesses in a database such that the information is associated with the content and the exhibitor to which the content relates. Other information could be detected by the detection module 2110 and correspondingly logged by the log module 2115 as well.

A contact threshold operation 2120 determines whether to transmit a report to an exhibitor regarding the logged content accesses associated with that exhibitor. The contact threshold operation 2120 can apply any of a number of tests to determine whether a lead should be validated, i.e., whether sufficient interest has been exhibited by an attendee that the exhibitor will want to contact that exhibitor to determine interest in conducting future business. Example tests can include: access of content associated with the exhibitor for greater than an exhibitor-selected or predetermined period of time; an exhibitor-selected or predetermined number of instances of access of exhibitor content; and/or the existence of any accesses of exhibitor content within a predetermined or exhibit-selectable period of time. Other tests are possible as well.

If the contact threshold operation 2120 determines that the threshold for delivering any qualified leads to the exhibitor has been met, operational flow branches “yes” to a notify module 2125. The notify module 2125 generates a notification of one or more qualified leads and delivers that notification to the exhibitor. The notification generated by the notify module 2125 can take any of a number of forms including an email to the exhibitor, a report generated and sent to the exhibitor by electronic or physical mail, or a notification displayed to the exhibitor in any of the user interfaces of FIGS. 12-15. An example of such a report is shown below in FIG. 22.

If the contact threshold operation 2120 determines that the threshold for delivering any qualified leads to the exhibitor has not been met, operational flow branches “no” to an end operation 2130. Additionally, operational flow proceeds from the notify module 2125 to the end operation 2130. The end operation 2130 signifies that the automatic lead validation has been completed with respect to a particular exhibitor.

Referring now to FIG. 21 overall, it is noted that the process 2100 can be performed separately for each exhibitor-attendee combination, or as part of a batch process for determining contacts on a per-exhibitor, per-event, or per-attendee basis. Furthermore, although the process 2100 is described above with respect to an exhibitor, an equivalent process could be performed, and equivalent data logging could occur in the systems described herein, related to access of contact data related to advertisers, attendees, or other individuals or entities having information stored within the electronic literature distribution system of the present disclosure.

FIG. 22 illustrates an example report 2200 to be sent to an event exhibitor displaying qualified leads, as generated using process 2100 of FIG. 21. The report 2200 provides information to an exhibitor regarding qualified leads associated with that exhibitor, by listing event attendees who have shown additional interest in the products or services provided by the exhibitor. The report 2200 can be presented to an exhibitor in any of a number of delivery formats, such as by email or through a web interface accessing the databases described herein.

The report 2200 includes header information 2202 which lists the exhibitor and other relevant information about the validated leads (e.g. the timeframe in which the leads are generated, the event with which the leads are associated, or other information). The report further includes one or more validated lead entries 2204, each of which display contact information for the trade show attendee, details regarding time, date, and duration of each access by that attendee, and the particular content accessed. Additional information can be included as well

The validated lead entries 2204 can be arranged in a number of ways. In certain embodiments, the validated lead entries are listed in order of priority, with those contacts rated highest listed earliest in the report 2200. In the specific example shown, a trade show attendee accessing content from an exhibitor a higher number of times or for a longer duration is listed above a contact making less contact and for a shorter duration. Furthermore, attendees or other leads making only minimal accesses of content associated with the exhibitor may selectively be excluded from the report, as preset by the exhibitor. In still other embodiments, the validated lead entries can be organized by event, so that exhibitors attending multiple events can easily view leads arising from each event to assess the quality of contacts made at that show, and to assist the exhibitor in remembering the identity of the attendee. A variety of other analytical tools can be used as well to determine a percentage of qualified leads generated at a trade show or other event, or other metrics regarding the overall population of individuals encountered by an exhibitor, an event promoter, or an event attendee.

As with the process 2000 of FIG. 20, the report 2200 is described with respect to an exhibitor receiving information regarding attendee content access. However, an equivalent report could be generated related to access of contact data related to advertisers, attendees, or other individuals or entities having information stored within the electronic literature distribution system of the present disclosure, and could be provided to any other entity registered as having access and data stored in the systems described herein.

The above specification, examples and data provide a complete description of the manufacture and use of the composition of the invention. Since many embodiments of the invention can be made without departing from the spirit and scope of the invention, the invention resides in the claims hereinafter appended.

1. An electronic information distribution system comprising:
an attendee handheld computing device;
an exhibitor data exchange system including an exhibitor computing device and a wireless communication unit;
a database configured to contain database records, the database records including database records related to an owner of the attendee handheld computing device and database records related to a registered user of the exhibitor data exchange system;
wherein the attendee handheld computing device is configured to exchange information with the wireless communication unit via a wireless communications link, thereby forming a link in the database between at least one record related to the owner of the attendee handheld computing device and at least one record related to the registered user of the exhibitor data exchange system.

2. The electronic information distribution system of claim 1, wherein the exhibitor data exchange system is positioned in an exhibitor booth.

3. The electronic information distribution system of claim 1, further comprising a kiosk having a plurality of user input stations configured to personalize the attendee handheld computing device to an event attendee.

4. The electronic information distribution system of claim 1, wherein the information includes a link identifying the owner of the attendee handheld computing device.

5. The electronic information distribution system of claim 1, wherein the information includes a link to product literature or media related to an event exhibitor associated with the exhibitor data exchange system.

6. The electronic information distribution system of claim 1, wherein the kiosk includes a docking station configured to receive the handheld computing device and program the handheld computing device with information associated with an event attendee.

7. The electronic information distribution system of claim 1, wherein the wireless communication unit of the exhibitor data exchange system is positioned generally in conjunction with an electronic product literature display at an exhibitor booth.

8. The electronic information distribution system of claim 1, wherein the exhibitor computing device includes a programmable circuit configured to:
periodically poll the wireless communication unit for information received from an attendee handheld computing device; and
upon determining the presence of information received from the attendee handheld computing device, display at least a portion of the information received from the attendee handheld computing device.

9. The electronic information distribution system of claim 8, wherein the at least a portion of the information includes a name of an attendee associated with the attendee handheld computing device

10. The electronic information distribution system of claim 1, further comprising an advertiser data exchange system including an advertiser computing device and a wireless communication unit, the advertiser data exchange system positioned generally in conjunction with an electronic advertising display.

11. A method of distributing information at an event, the method comprising:
generating a record of exhibitor information including contact information and electronic literature or media;
wirelessly distributing a link to the exhibitor information at the event, in response to a wireless request from an attendee handheld computing device;
wirelessly receiving information about an event attendee from the attendee handheld computing device; and
accessing, via a web portal, an event attendee contact information organization system containing information about the event attendee.

12. The method of claim 11, further comprising updating the exhibitor information after the event, thereby updating information viewable by attendees via the link.

13. The method of claim 11, further comprising, upon wirelessly receiving information about the event attendee, displaying on a computing device of an exhibitor data exchange system information identifying the event attendee to an event exhibitor.

14. The method of claim 13, wherein the information identifying the one of the plurality of attendees includes a name and a digital photograph.

15. A method of collecting exhibitor information at an event, the method comprising:
receiving an attendee handheld computing device;
linking the attendee handheld computing device to an attendee record;
orienting the attendee handheld computing device toward a wireless communication unit of an exhibitor data exchange system;
activating the attendee handheld computing device, thereby exchanging information with the exhibitor data exchange system; and
accessing, via a web portal, product literature or media related to an event exhibitor associated with the exhibitor data exchange system.

16. The method of claim 15, wherein exchanging information with the exhibitor data exchange system includes transmitting information about an attendee from the attendee handheld computing device.

17. The method of claim 15, wherein exchanging information with the exhibitor data exchange system includes receiving a link to the contact information and product literature or media.

18. The method of claim 15, wherein accessing the contact information and product literature or media includes providing information identifying an attendee for storage in a database.

19. The method of claim 15, wherein accessing the contact information and product literature or media includes accessing updated contact information and product literature or media that is changed after information is exchanged with the exhibitor data exchange system.

20. An information network for accessing and managing a plurality of media and contact information exchanged at an event environment between a plurality of event participants, the network comprising:
a database containing an allocated memory space for each event participant to store media and contact information; and
one or more database servers;
wherein the event participants can access and organize media and contact information by accessing the one or more database servers with a general purpose computing device running an instance of a Web-based software application.

21. The information network of claim 20, wherein an event exhibitor is allocated an exhibitor memory space in the database for storing a plurality of records containing Internet address links to product literature or media, and is allocated an exhibitor contact memory space for storing a plurality of event participant contact information.

22. The information network of claim 20, wherein an event attendee is allocated an attendee memory space in the database for storing a plurality of records containing exhibitor specific media, and is allocated an attendee contact memory space for storing a plurality of event participant contact information.

23. The information network of claim 21, wherein a master link specifies the location of the exhibitor memory space in the database.

24. The information network of claim 23, wherein the master link is transferred to an exhibitor communication unit for distribution to an attendee personal communication device.

25. The information network of claim 23, wherein the master link is stored in association with an attendee record for access by an attendee associated with the attendee record.

26. The information network of claim 23, wherein the one or more database servers host a Web portal such that an event participant can securely log-on and access the database via any computing device having network access capability and running an instance of the Web-based software application.

27. The information network of claim 20, wherein the Web-based software application includes a contacts browser module and an explorer module, wherein an action of launching the contacts browser module generates a Web page that renders an organized list of user contacts, and wherein an action of launching the explorer module generates an user interface such that locally stored media and contact information is accessible.

28. The information network of claim 27, wherein the list of user contacts is graphically rendered on the user interface as business card in a circular rolodex format.

29. A method of providing equipment for electronic literature distribution in an event environment, the method comprising:
providing a remote database configured to store exhibitor information and attendee information;
providing a plurality of data exchange devices to a plurality of exhibitors, each of the plurality of data exchange devices communicatively connected to the remote database;
charging each of the plurality of exhibitors a fee related to the data exchange devices provided to that exhibitor, the fee based on a number of expected attendees at the event, each data exchange device including a display and an optical interface;
providing, at no cost to attendees, a personal communication device to each of a plurality of attendees of the event, the personal communication devices configured to communicate with each of the plurality of data exchange devices via an optical interface;
providing a kiosk useable by the attendees to associate the personal communication device with personal information of that attendee, the kiosk communicatively connected to the remote database and configured to transmit the personal information of each of the attendees to the remote database;
hosting a Web application accessible to the plurality of exhibitors and the attendees, the Web application providing access to information exchanged between the personal communication device associated with an attendee and the plurality of data exchange devices to the attendee.

30. The method of claim 29, wherein the web application provides access to information received from the attendee to one or more of the plurality of exhibitors.

31. The method of claim 29, wherein the plurality of data exchange devices each include a computing system having a wireless network connection.

32. A method of validating sales leads collected using an event electronic literature distribution system, the method comprising:
providing access to electronic content in a database to an event attendee, the electronic content including content associated with an event exhibitor;
detecting accesses of the electronic content by the event attendee;
logging the accesses of the electronic content by the event attendee in an access log;
generating a report describing at least a portion of the access log;
transmitting the report to the event exhibitor.

33. The method of claim 32, wherein providing access to electronic content includes associating a link to the content with the event attendee in a database.

34. The method of claim 32, wherein the report organizes a plurality of records related to a plurality of event attendees in a predetermined order of interest to the event exhibitor.
